(19) United States
(12) Patent Application Publication
(10) Pub. No.: US 2026/0116323 A1
(43) Pub. Date: Apr. 30, 2026

(54) SYSTEM AND METHOD FOR PROVIDING MULTI-TIER MOBILITY SERVICES FROM A SINGLE VEHICLE PLATFORM

(71) Applicant: HYPRLABS INC., San Francisco, CA (US)

(72) Inventor: Tim KENTLEY-KLAY, San Francisco, CA (US)

(73) Assignee: HYPRLABS INC., San Francisco, CA (US)

(21) Appl. No.: 19/372,148

(22) Filed: Oct. 28, 2025

Related U.S. Application Data
(60) Provisional application No. 63/712,967, filed on Oct. 28, 2024.

(51) Int. Cl. B60R 16/037; B60J 3/04; B60W 30/182; B60W 60/00; G06Q 10/0631; G06Q 50/47; G08G 1/00; H04L 9/40

(52) U.S. Cl. CPC B60R 16/037; B60W 30/182; G06Q 10/06315; G06Q 50/47; G08G 1/22; H04L 63/04; B60J 3/04; B60W 60/00

(57) ABSTRACT

A system for enhancing autonomous ride-sharing network liquidity through adaptive vehicle configuration is disclosed. The system comprises a fleet of vehicles with dynamically activatable features, a central control system for monitoring market demand and vehicle availability, and modules for feature activation and dynamic configuration and deployment. This invention allows a single vehicle type to serve multiple market segments by dynamically adjusting its feature configuration and tier deployment based on real-time demand, thereby optimizing fleet utilization and enhancing service flexibility.

### PRIORITY APPLICATION

This application claims the benefit of and priority to U.S. Provisional Application No. 63/712,967 filed 28 Oct. 2024, titled “System and Method for Providing Multi-Tier Mobility Services from a Single Vehicle Platform” (Atty. Docket No. HYPR 1004-1), which application is incorporated herein by reference.

### RELATED CASES

This application is also related to the following commonly owned applications, all of which are incorporated by reference for all purposes:

U.S. patent application Ser. No. 19/352,372 filed 7 Oct. 2025, titled “Synchronized Autonomous Vehicle Motorcade for Group Transportation” (Atty. Docket No. HYPR 1003-3); which claims the benefit of and priority to U.S. Provisional Application 63/704,453 filed 7 Oct. 2024, titled “Synchronized Autonomous Vehicle Motorcade for Group Transportation” (Atty. Docket No. HYPR 1003-1) and U.S. Provisional Application 63/708,220 filed 16 Oct. 2024, titled “Synchronized Autonomous Vehicle Motorcade for Group Transportation” (Atty. Docket No. HYPR 1003-2).

U.S. patent application Ser. No. 18/731,115 filed 31 May 2024, titled “System and Methods for Providing Driver Assistance Alerts Using an End-To-End Artificially Intelligent Collision Avoidance System and Advanced Driver Assistance Systems” (Atty. Docket No. HYPR 1002-1) which claims the benefit of and priority to U.S. Provisional Application 63/524,213 filed 29 Jun. 2023, titled “Scalable Training and Validation for an End-To-End Autonomous Driving Model” (Atty. Docket No. HYPR 1001-1).

PCT Application No. PCT/US2024/036289, filed 29 Jun. 2024, titled “System and Methods for Providing Driver Assistance Alerts Using an End-To-End Artificially Intelligent Collision Avoidance System and Advanced Driver Assistance Systems” (Atty Docket No. HYPR 1002-2WO), which is incorporated by reference for all purposes.

U.S. patent application Ser. No. 18/431,827, filed 2 Feb. 2024, titled “Multi-Functional Inventory Storage and Delivery System” (Atty. Docket No. HYPR 1000-2); which claims the benefit of and priority to U.S. Provisional Application 63/443,342 filed 3 Feb. 2023, titled “Multi-Functional Inventory Storage and Delivery System” (Atty. Docket No. HYPR 1000-1).

### FIELD OF THE TECHNOLOGY DISCLOSED

The technology disclosed relates to end-to-end neural networks configured for autonomous and semi-autonomous driving. In particular, the technology disclosed relates to a scalable method and apparatus for reconfigurable service tiers across a fleet or motorcade of autonomous or semi-autonomous vehicles.

### BACKGROUND

The technology disclosed relates to adaptive configuration of vehicles in autonomous vehicle fleets and systems for providing tiered mobility services from a single vehicle platform. Conventional ride-sharing and fleet management systems typically rely on separate vehicle classes or hardware configurations to distinguish between different levels of service, such as economy, comfort, or premium tiers. Because each vehicle class and service level depends on fixed, pre-installed features, operators are required to manage multiple vehicle models, each with unique maintenance, inventory, and utilization requirements. This segmentation introduces inefficiencies in fleet operation and capital deployment, as vehicle utilization becomes constrained by the physical configuration of hardware.

An opportunity arises to increase operational efficiency and service flexibility by enabling multi-tier compatible, reconfigurable vehicle platforms, in which a single autonomous vehicle platform can serve multiple market segments through secure, real-time activation or deactivation of vehicle features. By controlling comfort and performance subsystems electronically (such as seating, display, lighting, and drive modes) a vehicle control system can dynamically reconfigure vehicles across tiers without modifying hardware or removing the vehicle from service. This capability allows fleets to fluidly respond to short-term fluctuations in demand, reduce idle time, and offer personalized user experiences across a range of price points, all while maintaining a consistent hardware base and unified control architecture.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 is a block diagram of a fleet system.

FIG. 2 is a block diagram of an autonomous vehicle.

FIG. 3 is an architectural-level schematic of an end-to-end conditional imitation learning model for autonomous driving.

FIG. 4 is a block diagram of example comfort and performance features.

FIG. 5 is a block diagram of additional example comfort and performance features.

FIG. 6 is a message flow diagram for coordinated control of navigation features across a motorcade.

FIG. 7 illustrates a computer system that can be used to implement the technology disclosed, in accordance with certain implementations of the present disclosure.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

Ridesharing companies offer tiers of service, based on vehicles supplied by the drivers that they contract. Tiers have descriptive names such as black SUV for luxury rides with professional drivers, comfort for newer cars with extra legroom, standard for affordable rides, and lower cost vehicles for lower fare classes. Autonomous fleets are custom built, and self-driving electronics are expensive. Hence, cars for each autonomous fleet have been built to a single specification, sometimes evolving with design changes, which has led to a single tier of service, e.g., a luxury ride requires a dedicated vehicle and a budget ride requires another.

The technology disclosed enables autonomous fleets to offer tiered service like ridesharing services, by enabling or disabling features of vehicles, without needing to build tiered vehicle configurations. The vehicles within the fleet are built on a common platform equipped with selectively activatable comfort and performance features controlled by subsystems of the vehicle, such as seating, audio, display, and drive mode controls. The comfort and performance features can be remotely enabled or disabled by a central vehicle control system. The vehicle control system communicates securely with each vehicle, transmitting configuration data that instantly modifies the ride experience. A car configured for standard service on one trip may be seamlessly reconfigured for premium service on the next, all through encrypted over-the-air commands.

The technology disclosed includes a reconfigurable vehicle platform that can operate in multiple modes based on the activation or deactivation of features, such as reclining seats, enhanced audio, entertainment system features, or electrochromic window tint. Because the transformation occurs through software-driven control of existing hardware, operators can easily scale capacity across multiple service tiers without maintaining separate fleets. The autonomous vehicle fleet can operate in motorcade mode, a feature that transforms mobility into a social experience. In this mode, multiple autonomous vehicles are linked together through a shared control layer that synchronizes motion, entertainment, and communication across the group. Passengers in separate vehicles can speak face-to-face over secure video links, enjoy synchronized music or streaming content, and travel in visually coordinated convoys distinguished by dynamic exterior lighting. The same architecture that activates comfort features in a single car orchestrates these experiences across multiple vehicles, creating a collective journey.

A central control system continuously monitors market conditions, fleet distribution, and tier demand in real time. Machine-learning models analyze ride requests, traffic patterns, and regional events to predict where and when different service tiers will be needed. Vehicles are reassigned automatically, and features are toggled to match the new configuration before the next ride begins. This responsiveness allows operators to maintain near-optimal fleet utilization while ensuring riders are consistently matched with the experience they expect. Interactions between the fleet and the control system is secure and efficient, employing authenticated encryption protocols and edge-level processing to preserve low latency. Commands propagate through distributed computing nodes, ensuring near real time responsiveness while preserving centralized oversight.

Offering multiple tiers implemented by enabling or disabling features offers several advantages over current fleets. Increased fleet utilization and efficiency will result, as compared to offering tiers via multiple platforms, because any vehicle can be remotely and electronically configured to multiple service tiers. Enhanced service flexibility and responsiveness to market demand will result from reconfiguring part of a fleet from one tier to another based on changes in demand day-to-day and second-by-second. Customer experience will be improved by offering multiple price points and features to match. The autonomous fleet will have significant reduced costs of service, as compared to developing, manufacturing and maintaining multiple vehicle types. The fleet will be able to adapt quickly to changing market conditions and customer preferences.

This framework enables autonomous vehicle fleets to operate not as independent units, but as coordinated systems capable of adapting collectively to real-world conditions and user preferences. The conversation now turns to an overview of terminology used to describe the technology disclosed for the sake of clarity, followed by an introduction of the disclosed system, according to some implementations.

### Terminology

For clarity and completeness, certain terms used herein are introduced below. The terminology and corresponding examples are provided to facilitate consistent interpretation throughout the description and claims. Unless expressly stated otherwise, the terms are not intended to be limiting and may encompass other variations, equivalents, or analogous structures apparent to those skilled in the art. The examples provided to elaborate upon any particular term are illustrative and non-limiting. As used herein, the term “autonomous vehicle” can refer to a vehicle (e.g., car, truck, transporter robot, bus, etc.) that includes one or more systems configured to perform driving operations with reduced or minimal human input. For conciseness, “autonomous” may be used herein as an umbrella term that encompasses vehicles that are fully autonomous, semi-autonomous, or partially autonomous, including vehicles that operate under human supervision or intervention. Put differently, any implementation described with respect to an autonomous vehicle is understood to be similarly applicable to a semi-autonomous or partially autonomous vehicle, even if a semi-autonomous or partially autonomous implementation is not explicitly described for the sake of conciseness. An autonomous vehicle may rely on local onboard control logic, onboard control logic associated with another autonomous vehicle connected via V2V communication, remote coordination from a server, or a combination of both. In some implementations, certain features or functions of the vehicle can be partially automated through server control to achieve coordination with other vehicles, such as synchronizing acceleration or adjusting route timing, while still operating without continuous human input. “Autonomous” as used herein further includes vehicles configured to operate autonomously in one mode of operation while another mode of operation may allow for the vehicle to accept human input related to one or more vehicle operations. For example, a vehicle may operate in a fully autonomous mode during group coordination, in a supervised or “shadow” mode when learning from a human driver, and/or under a manual override condition when user input is permitted or required for safety (e.g., implementations involving restrictions on autonomous driving in order to comply with law or regulation). The vehicle may dynamically transition between these modes in response to environmental or system conditions. Autonomous vehicles may be referred to simply as “vehicles” with respect to certain implementations of the technology disclosed.

The autonomous vehicles described herein can perform end-to-end processing of data collected by a camera or sensor connected to/integrated within the vehicle. As used herein, the term “camera system” can refer to any combination of data-acquisition devices mounted on or communicatively connected to a vehicle for perceiving its surroundings. Non-limiting examples include images and/or video feeds collected by one or more external 2D or 3D cameras, sensor data collected from a LiDAR array (e.g., detection of road features and proximity data), radar sensor(s) for collision avoidance, and/or an environmental sensor package configured to monitor traffic lights and weather conditions. A camera/sensor system can provide image, depth, or positional data used by the vehicle or a coordinating server for navigation and environment interpretation. The autonomous vehicles described herein can further leverage an accelerometer and a GNSS feed. For conciseness, implementations of the technology disclosed frequently refer to the data collection systems leveraged for collection of input data for the E2E driving model as “camera systems,” but this term is not intended to limit the data collection features strictly to cameras. Similarly, reference to a “sensor” may refer to a camera, a 3D sensor, a LiDAR sensor, and so on.

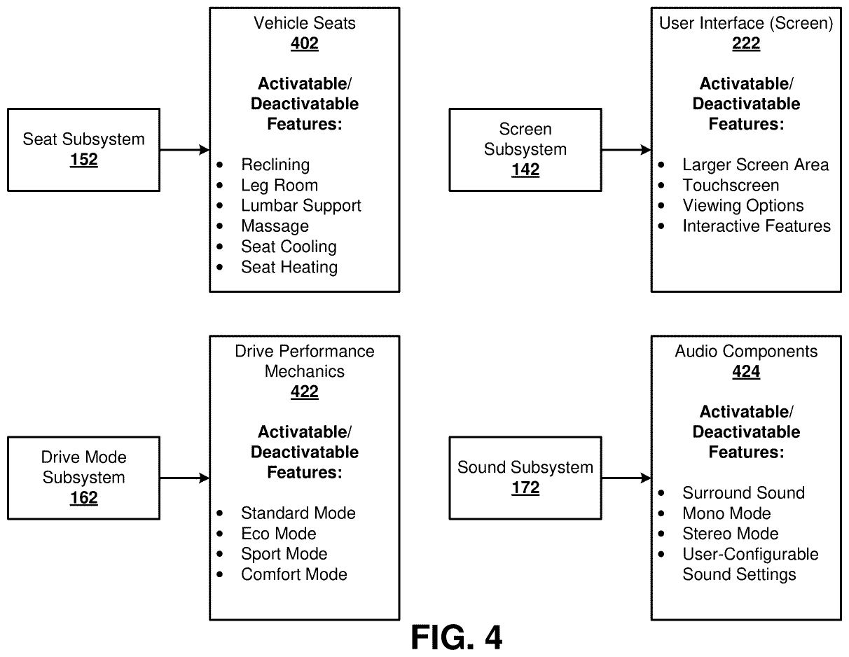

As used herein, the term “end-to-end autonomous driving model” (used synonymously with “E2E model,” “autonomous driving model,” and so on) can refer to a computational model configured to generate actuation control signals from input sensor and route data. The model can be machine-learned, algorithmic, or rule-based, trained on real-world or simulated data, such as a deep learning model like a transformer. An E2E model may process input data to control steering and braking, receive GNSS and map data to update route predictions, or output acceleration and turn commands to an actuation interface, discussed further with respect to FIG. 4 below.

As used herein, the term “driving data” can refer to sensor, perception, and/or environmental data used by an E2E model to determine actuation or navigation behavior. Driving data can include, e.g., video feeds and/or LiDAR feeds, GNSS coordinates and speed readings (e.g., accelerometer data) used to estimate position and velocity, or inertial and steering-angle measurements used for motion control. Driving data can be generated locally by the vehicle or received from other vehicles or systems to inform operation. More generally, the term “vehicle data” is used herein to encapsulate not only driving data, but operational data associated with one or more vehicles, such as the vehicles within a motorcade, including but not limited to driving data (e.g., GNSS data, video data, LiDAR data), vehicle health data (e.g., fuel and/or battery status, tire or brake status, etc.), communication logs (e.g., back-end communication between the autonomous vehicles, server, and other system components as well as user communication between passengers), or navigation updates. Vehicle data can be used to coordinate navigation, synchronize itineraries, or stream multimedia content across a motorcade.

As used herein, the term “motorcade” can refer to a group of two or more autonomous vehicles that operate under coordinated control toward one or more destinations. Vehicles in a motorcade may be physically proximate, spaced apart, or traveling along distinct routes while remaining logically linked through shared data exchange or itinerary management. “Physically proximate” can refer to vehicles separated by distances small enough to maintain line-of-sight or sensor-based detection, such as within about 1 meter to 50 meters, 5 meters to 100 meters, or any range bounded by these values. In highway or urban conditions, proximate operation may correspond to vehicles within one to three car lengths or within a time headway of less than two sec. at prevailing speeds. “Spaced apart” can refer to separations larger than those used for proximate travel yet still coordinated within a shared motorcade session, such as vehicles located within 0.5 kilometers, 1 kilometer, or 5 kilometers of one another, or within a 5-min. travel window based on dynamic routing. In some implementations, vehicles in a motorcade may be located across different traffic corridors, road segments, or parallel routes but remain logically synchronized through shared navigation, communication, or multimedia control. Unless stated otherwise, “motorcade” may be used analogously to “fleet,” “fleet subset,” “convoy,” or “coordinated vehicle group.”

As used herein, the term “transportation itinerary” can refer to data representing a pre-determined, and optionally adaptive/dynamically-updated, set of travel parameters for one or more vehicles. The transportation itinerary can include driving route(s), estimated travel times corresponding to respective driving routes or leg(s) of driving routes, arrival, departure, pick-up or drop-off time(s), intermediate stop(s), or assignments of respective sets of one or more autonomous vehicles to a specific pick-up time, destination location, and/or driving route. A transportation itinerary may include the route and estimated arrival times for a group of vehicles traveling to a concert, updated departure times reflecting a traffic delay, or new destination data following a user request to add an intermediate stop.

As used herein, the term “coordinated control” can refer to an orchestration or management of one or more integrated functions across at least two vehicles in a motorcade based on shared or exchanged data. Coordinated control may include centralized management by a server or distributed coordination among vehicles. Coordinated control may adjust navigation routes for all vehicles based on updated traffic data, propagate a user's message or media selection to every vehicle in the motorcade, or modify lighting display parameters simultaneously across the fleet. As used herein, the term “integrated function” can refer to a feature, a capability, and/or a service implemented across two or more vehicles within a motorcade, such as navigation, communication, or multimedia presentation. An integrated function can include synchronized route planning between vehicles, coordinated video streaming for participants across cars, or shared communication routing for group messages. The term encompasses functions centrally facilitated by the server or jointly executed by the vehicles. As used herein, the term “feature” or “function” can refer to a discrete capability, operation, or service implemented by one or more system components. Examples include a feature for initiating or modifying a transportation itinerary, a function that establishes secure communication links between vehicles, or a multimedia control operation for selecting or synchronizing content. Such vehicle operation terms may be used synonymously and are not restricted to software-based or hardware-based implementations.

As used herein, the term “end user application” or “end user app” can refer to a software or hardware interface operated by a user to interact with the system. The application may allow users to request, join, or manage a motorcade, update destinations, send communications, and/or interact with entertainment functions. Examples can include a mobile app that displays synchronized arrival times, a tablet interface allowing passengers to send chat messages between vehicles, a user interface integrated within the interior of an autonomous vehicle, a remote control device (e.g., remote controllers, gaming controllers, keyboards, touchscreen displays, and so on) accessible to a user (e.g., a participant in the motorcade, also referred to as a passenger, or another individual associated with the management or operation of the motorcade service), and/or a web-based interface permitting passengers and/or fleet administrators to modify motorcade sessions.

As used herein, the term “media content” can refer to data suitable for presentation through a user interface of a vehicle or other user device, such as a smart phone, tablet, laptop, etc. The terms “multimedia,” “media,” “content,” “content stream,” etc. may encompass, without limitation, audio, video, image, or interactive materials. Examples include synchronized playback of a music playlist across vehicles, streaming of a shared video feed or live event, and interactive games or polls conducted between participants in different vehicles. Media content may originate from a participant, from 2^{rd}-party sources, or from system-provided content libraries. As used herein, the term “lighting display parameter” can refer to any control data defining visual characteristics of a vehicle's lighting, including color, brightness, timing, duration, or animation pattern. Lighting display parameters can coordinate exterior lighting across vehicles to display a unified visual pattern, adjust interior lighting to match the rhythm of shared music playback, or modify brightness in response to proximity or environmental conditions. The term can include internal or external displays used for aesthetic, communicative, or safety purposes.

As used herein, the term “synchronized” can refer to alignment or coordination among vehicles, operations, or data streams such that they remain temporally or logically consistent within an acceptable tolerance. Synchronization may be absolute or relative, and different implementations may define synchronization differently. Synchronization may occur exactly simultaneously across vehicles, may be maintained within a delay of less than one, three, or five sec., or may maintain alignment within a predefined time window such as ±30 sec., ±1 min., ±5 min., or any range bounded by these values. In some cases, synchronization can be relative, such as maintaining an arrival time within ±10 percent of an original estimate or within a few sec. of another vehicle's arrival. As used herein, the term “real time” (or “near real time”) can refer to communication, processing, and/or control executed with latency that is sufficiently low as measured by ability to maintain effective coordination during ongoing operation. The degree of real-time performance may vary by implementation. Real-time operation can include latency less than one 2^{nd} in a navigation control loop, latency less than three sec. in multimedia synchronization, or latency less than five sec. in user message propagation. The term may further encompass near-real-time operation where minor latency does not materially disrupt coordinated behavior.

As used herein, the term “time window” can refer to a range of permissible differences in timing between related events such as arrivals, departures, or data updates. A time window can be defined in absolute or relative terms. A time window may allow arrival times within 30 sec., 1 min., 3 min., or 5 min. relative to another autonomous vehicle (or an inclusive range bound by any two of these values), specify a synchronization tolerance of 5 min., 10 min., or 15 min. (or an inclusive range bound by any two of these values) during long-distance travel, or define a variable interval based on travel duration or dynamic conditions. The time window may be preconfigured, adaptive, or determined by user input. As used herein, the term “delay” can refer to a temporal offset between an expected and actual event time, including latency in data transmission, processing, or travel completion. Delay may represent additional time caused by traffic, correspond to network latency in transmitting media content, or indicate deferred synchronization due to user confirmation requirements. Delay values can be expressed as absolute durations or relative deviations.

As used herein, the term “coordinated” can refer to operations or functions that are adjusted or aligned relative to one another based on shared logic or exchanged data. Coordinated functions may include updating multiple itineraries to preserve synchronized arrivals, aligning communication sessions between vehicles, or managing distributed playback of shared media. Coordination may occur proactively or reactively based on situational data. As used herein, the term “integrated” can refer to functions or subsystems that operate jointly or interoperably as part of a larger system. Integrated systems may share data between navigation and communication modules, operate multimedia control logic across several vehicles, or execute server-based and vehicle-based processes concurrently. The discussion now turns to an overview of the disclosed multi-tier service fleet, in accordance with some implementations of the technology disclosed.

The technology disclosed provides a system and method for dynamically configuring autonomous vehicle features to provide tiered service from a single, adaptable vehicle platform. Components can include one or more of an adaptive vehicle control platform equipped with selectively activatable comfort and performance features, a central control system for real-time market demand and vehicle availability monitoring, a feature activation module for remote enablement/disablement of vehicle features, and/or a dynamic configuration and deployment module for assigning vehicles to service tiers and engaging the feature activation module to control the selectively activated comfort and performance features consistent with assignment to the service tiers.

The technology disclosed builds on prior disclosures for coordinating multiple autonomous vehicles to create a synchronized group transportation experience. Features available include a mobile application for booking multiple autonomous vehicles for group travel, inter-vehicle communication system for audio and video sharing between passengers in the group vehicles, synchronized entertainment systems across multiple vehicles in the group, or external lighting patterns that indicate the motorcade's presence to other road users. All or at least two or three of these features combine into systems and methods practicing the motorcade technology disclosed.

This technology provides a novel solution for tiered services including group transportation in motorcades of autonomous vehicles, offering a unique, connected experience for passengers while maintaining the flexibility of individual vehicles. The system enhances safety, communication, and entertainment for groups traveling together, potentially revolutionizing social outings and group transportation.

### System Overview

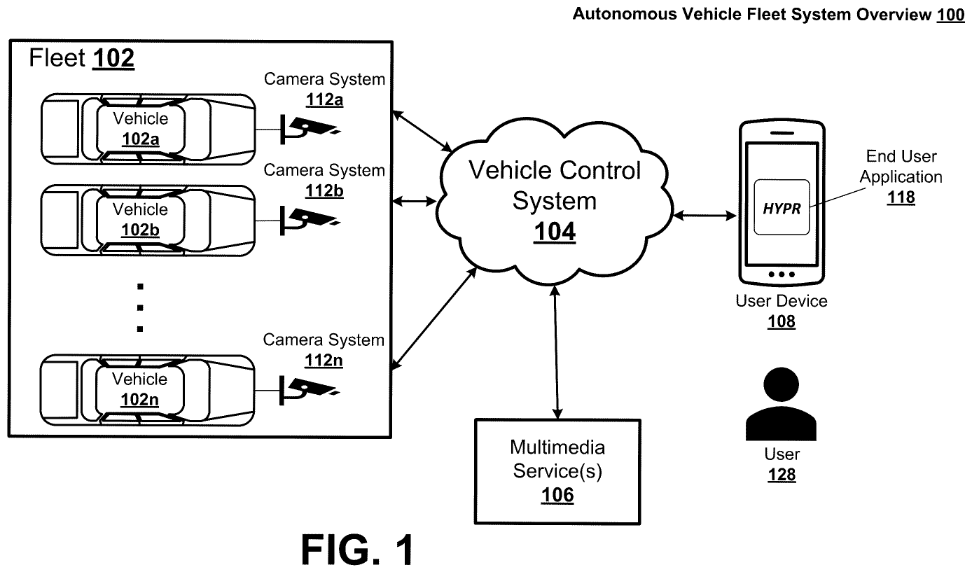

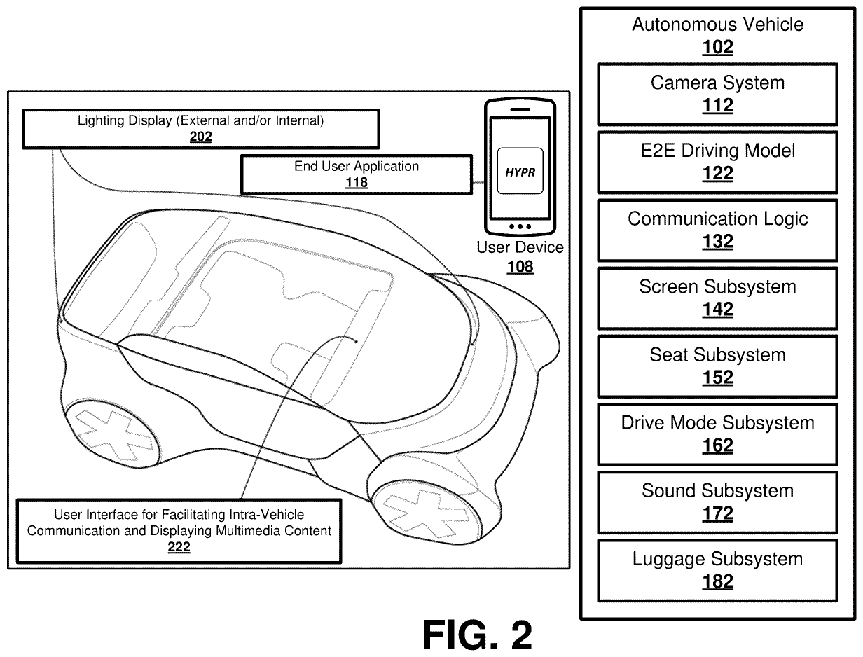

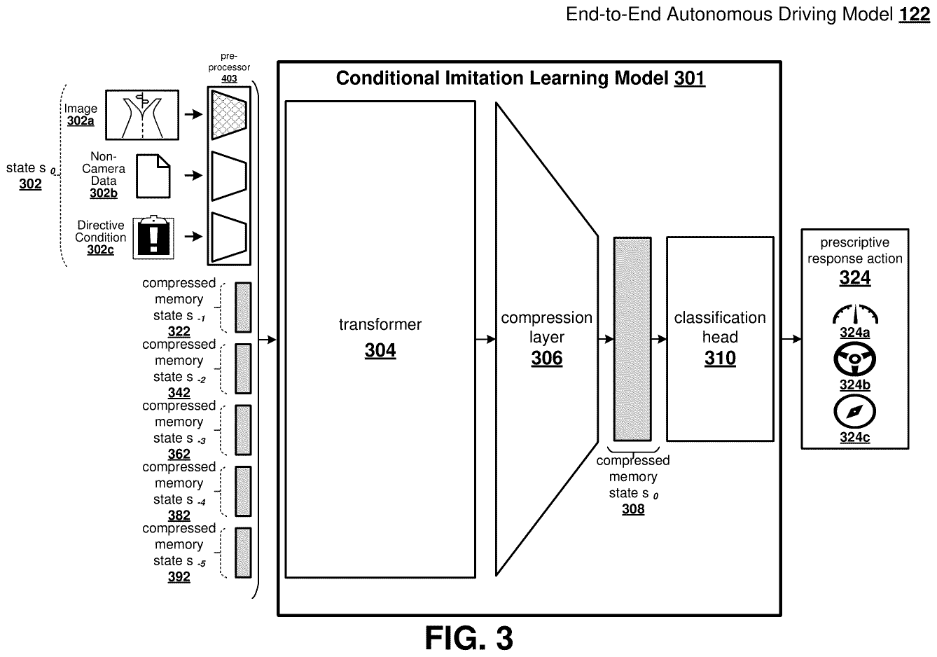

FIG. 1 illustrates a multi-tier autonomous fleet system 100 including a fleet 102 of autonomous vehicles (102a, 102b, . . . 102n, each with a respective camera system 112), a motorcade vehicle control system 104, one or more multimedia services 106, and user device(s) 108 executing an end-user app 118 associated with a user 128. The vehicle control system 104 coordinates the configuration and deployment of vehicles among multiple service tiers by exchanging data with the vehicles 102a-102n and with the end-user app 118. In various implementations, vehicles can be dynamically assigned to different service tiers (such as standard, comfort, or premium) based on current market demand, user selections, and fleet availability. An autonomous vehicle 102 can include various subsystems (e.g., seat, display, lighting, and audio subsystems) capable of reconfiguration including selective activation or deactivation of comfort or performance features to provide the experience associated with the assigned service tier. Camera system 112 provides perception inputs used by the end-to-end autonomous driving model 122. Subcomponents of the autonomous vehicles 102 are described in further detail with reference to FIGS. 2-3.

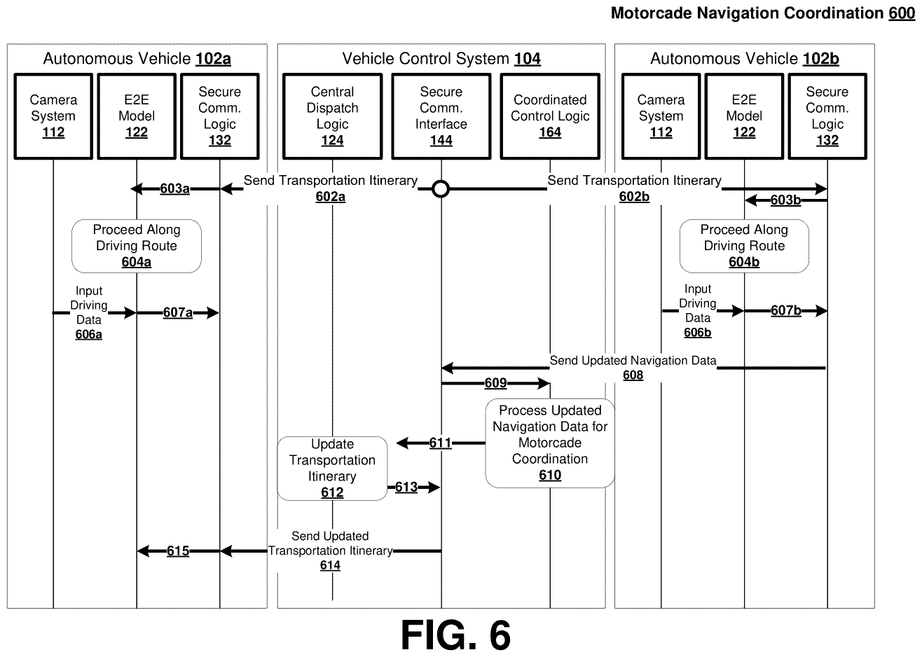

The vehicle control system 104 can further include, at least, a central dispatch logic 124, a secure communication interface 144, and a coordinated control logic 164, as described in further detail with reference to FIG. 6. The central dispatch logic 124 can receive market demand and user request data and generate configuration data based on the received market demand and user request data. The central dispatch logic 142 can also re-allocate autonomous vehicles 102 between the various available service tiers. The secure communication interface 144 can establish secure communication links (e.g., authenticated and/or encrypted connections) with vehicles 102a-102n and/or with the end-user app 118, supporting bi-directional messaging, itinerary distribution, and media/communication signaling. The coordinated control logic 164 can process vehicle data reported from the fleet 102 in a motorcade mode, including user inputs, location, timing, and sensor-derived updates to maintain alignment of integrated functions. For example, when one vehicle reports a traffic slowdown, the coordinated control logic 164 can direct the central dispatch logic 124 to update the transportation itinerary via 124 and secure communication interface 144 to subsequently transmit revised route, timing, or media-sync parameters to the motorcade such that shared experiences may remain synchronized.

In many implementations, the technology disclosed leverages vehicle control system 104 to configure tiers of comfort and performance features among vehicles in an autonomous vehicle fleet through coordinated communication between an onboard communication logic of a vehicle 102 and the central vehicle control system 104. Vehicle control system 104 can receive data from user requests, current usage patterns and historical usage patterns, additional contextual data about traffic status or upcoming events in the geographic region expected to impact traffic (e.g., a social event like a concert or sports game, or an ongoing event like the shutdown of a major highway for a repair project). Vehicle control system 104 can further receive data from an onboard communication logic of the vehicles 102a-102n within the fleet. The onboard communication logic can exchanges data with the vehicle control system 104, such as current vehicle location, subsystem readiness, and tier configuration state. Data can be exchanged continuously, at specific time intervals, or triggered by particular conditions like a prompt for information by the vehicle control system 104.

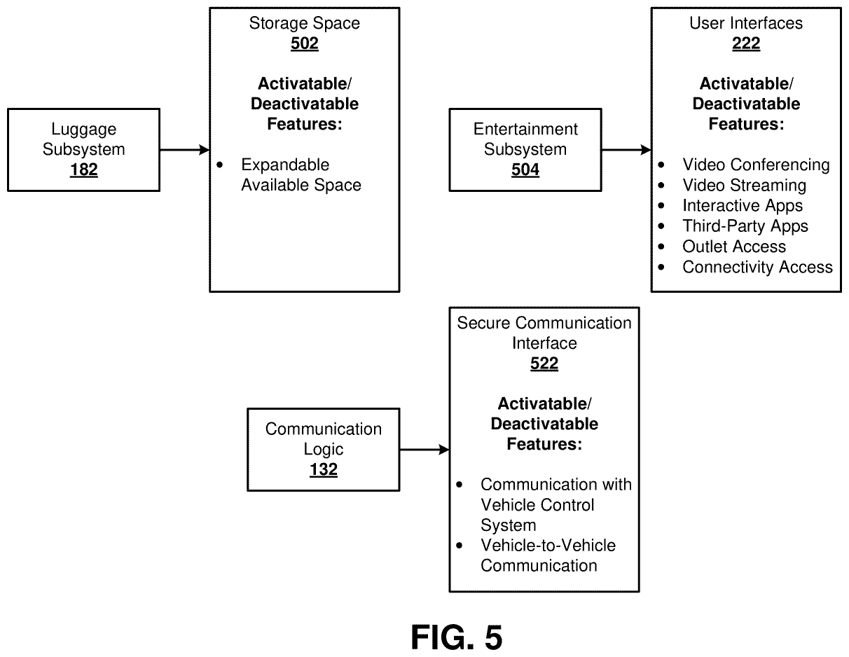

The vehicle control system 104 can track demand for vehicles across a defined service region by aggregating ride requests received from user applications and categorizing them according to requested service tiers. Based on this tracked demand, vehicle control system 104 determines an optimal allocation of vehicles among available tiers, considering factors such as geographic proximity of particular vehicles to requesting users, availability of vehicles in each tier, and the performance characteristics of each vehicle. Responsive to the determined allocation, the control system transmits reconfiguration data to individual vehicles 102 through the secure communication channel. The onboard communication logic receives and processes these commands to initiate activation or deactivation of relevant comfort and performance features, such as seat recline parameters, display size, sound mode, or drive performance settings, thereby implementing the tier reassignment in real time. This bidirectional communication framework enables continuous synchronization between the fleet-level demand model and the individual vehicle configuration states, allowing the system to dynamically adapt the fleet composition to current market conditions. In some implementations, the communication interface is a secure communication channel that relies on authentication and encryption protocols. In one implementation, the communications are end-to-end encrypted. The vehicle control system 104 can transmit reconfiguration data for activation or deactivation of features in order to allocate a particular vehicle to a particular service tier, or to upgrade/downgrade a specific feature in relation to a specific user's request for a transportation session. The reconfiguration of vehicle subsystems and comfort or performance features thereof is discussed in further detail with respect to FIGS. 4-5.

Alternative implementations can execute 124, 144, and 164 on cloud resources, edge nodes, or a combination thereof, and can apply different update intervals depending on function. The vehicle control system 104 can further interoperate with multimedia service(s)s 106 for content selection, stream distribution, or presentation of other media features in various service tiers. More specifically, the vehicle control system 104 can be implemented as one or more computing nodes operating within a centralized cloud environment, distributed edge network, or hybrid configuration. To ensure consistent communication with the fleet 102, the vehicle control system 104 supports multiple concurrent connection types, including persistent cellular data links (e.g., 4G, 5G), Wi-Fi-based backhaul connections, satellite relay, and low-latency short-range protocols suitable for direct coordination in enabled geographic regions. For example, control messages and synchronization commands may be prioritized on a low-latency cellular or DSRC channel, while large multimedia payloads or diagnostic data may be streamed over Wi-Fi or cached for batch upload through a delayed satellite connection.

The vehicle control system 104 can maintain temporary data storage and/or persistent data storage to support operational continuity and analytics. Real-time operational data (e.g., driving data, vehicle locations, routing states, and/or link-up progress) may be held accessibly in volatile memory or an SSD drive to enable immediate access by the coordinated control logic 164. Persistent logs, including historical itineraries, connection statistics, error events, and/or user interaction data from a user interface or end-user app 118, can be stored within secure databases or object storage systems. These records can allow analysis for system performance optimization (e.g., model training and validation), user data collection, fleet maintenance planning, or compliance auditing. For example, historical travel patterns can be used to predict demand for different service tiers or to generate anonymized statistics describing vehicle performance across different environments.

In some implementations, data collected by the vehicle control system 104 may be used to improve routing intelligence and predictive coordination. For instance, aggregated fleet data can identify high-density travel corridors where proactive grouping increases efficiency, or may refine the estimation models used to calculate pick-up, arrival, and/or departure times for subsequent sessions. In some cases, the vehicle control system 104 can transmit summarized metrics to external systems such as traffic information services or city transportation platforms, enabling coordinated infrastructure-level responses while preserving user privacy (such as through anonymization or encryption layers managed by the secure communication interface 144).

The vehicle control system 104 can further provide media streaming and content management capabilities through connection with the one or more multimedia service(s) 106. Multimedia services 106 may be integrated within the motorcade services, linked via third-party APIs, etc. The coordinated control logic 164 can act as a media orchestrator, managing group sessions in which multiple vehicles 102 receive synchronized audio or video streams. Depending on available network capacity, the vehicle control system 104 may employ adaptive bitrate streaming, predictive caching, or pre-buffering strategies to maintain consistent playback among vehicles 102a-102n even under variable conditions. In some implementations, the vehicle control system 104 can host an internal content repository for curated experiences (e.g., music playlists, lighting sequences, and/or live interaction with interactive graphical activities or games) while the multimedia services 106 provide external streaming or cloud content sources.

In some examples, the vehicle control system 104 may integrate optional analytics or feedback modules configured to evaluate tier performance and user engagement. For instance, the server may log playback synchronization offsets between vehicles, analyze latency trends, and use the data to dynamically adjust future service. These feedback mechanisms can enable refinement of the coordinated control logic 164 over time.

The fleet of autonomous vehicles 102 includes a plurality of autonomous vehicles 102a-102n, each equipped with onboard computing and communication elements configured to exchange information with the vehicle control system 104 through the secure communication interface 144. The subcomponents of the autonomous vehicles 102 are described in further detail with respect to FIGS. 2-3. Each vehicle 102a-102n can operate primarily in an independent mode while participating as part of a coordinated group or motorcade during shared sessions. The vehicles may be privately owned, commercially operated, or fleet-managed units dynamically assigned by the vehicle control system 104 to fulfill transportation itineraries.

Each vehicle can connect with one or more perception subsystems collectively referred to as a camera system 112, which may include video cameras, LiDAR, radar, GNSS receivers, and inertial sensors. The data produced by the camera system 112 can support local control of the corresponding individual autonomous vehicle, as well as intervehicle coordination within the motorcade facilitated by the vehicle control system 104. An onboard processor can process these inputs through control algorithms or learned driving models (e.g., the E2E model of FIG. 3) to determine steering, accelerator, and braking commands while maintaining communication with the vehicle control system 104 to receive updates to itinerary, spacing, or media synchronization state.

The onboard computing environment of an autonomous vehicle 102 may further maintain local storage or cache structures for temporarily holding vehicle data, itinerary segments, and synchronization state data received from the vehicle control system 104. This local caching enables continued operation in the event of transient communication loss. When connectivity resumes, the vehicle can upload accumulated vehicle data (e.g., activation or use status of a particular comfort or performance feature, position logs, media synchronization offsets, and network statistics) back to the vehicle control system 104 for reintegration. The caching subsystem may use a rolling buffer or write-ahead log so that continuity of itinerary and media synchronization is preserved even during extended offline operation.

The autonomous vehicles 102a-102n may also include a redundant safety controller configured to assume control if communication with the vehicle control system 104 or the motorcade group is interrupted. In such cases, the vehicle can continue operating autonomously to its current or next assigned waypoint using stored route and timing data until the link with the secure communication interface 144 is re-established. This safety redundancy can be implemented through hardware duplication, sandboxed control software, and/or cloud-assisted shadow mode operation where a local model continues executing pre-authorized commands until a verified update is received.

During active motorcade sessions, vehicles in the fleet 102 may exchange coordination data directly with one another using peer-to-peer links to reduce latency and support localized decision-making. Such peer-to-peer exchanges can occur over dedicated short-range communication (DSRC), 5G, or ad-hoc Wi-Fi channels. For example, vehicles 102a and 102b traveling in proximity may directly exchange relative velocity and braking data to maintain safe spacing, while still reporting summary information to the vehicle control system 104 for global synchronization. The peer links can also transmit lighting synchronization commands, enabling continuous multi-vehicle illumination patterns even when a vehicle temporarily loses connectivity to the central network.

Each vehicle's onboard system of hardware and software can support multiple service tiers, such as a premium tier and a standard tier, for example. A premium service tier, also referred to as premium mode, can include at least two of a premium mode, e.g., an activated feature of reclining seats, an expanded main screen for entertainment and conferencing, a surround sound system with active noise cancellation, enhanced drive performance modes, or an expanded luggage capacity. Premium mode can also include at least two of a premium mode of a higher wattage outlet up to 100 watts, a user controllable tint parameter of an electrochromic glass of vehicle windows, and an in-seat feature including a lumbar support, a massage mode, a seat cooling parameter, or a seat heating parameter. In a standard mode, at least one premium feature can be deactivated, such that seats do not recline, a main internal cabin display having a reduced screen size or fewer viewing options, a sound system in a mono or stereo mode, an economy driving mode, or a reduced luggage capacity. In another example, standard mode can include a locked out feature such that an outlet is restricted to 20 watts, a tint of a window is invariable, or a seat feature is invariable.

An autonomous vehicle 102a in the fleet is equipped with a suite of comfort and performance features that can be selectively activated or deactivated. These may include reclining seats (e.g., a standard tier in which the seats can adjust limited to +/−15 degrees, but not recline and no leg rest versus a premium tier with an expanded range of motion and seat adjustments), an expanded main screen (e.g., upgrading from one tier to a higher tier causes the screen to go from a slim line screen to a cinema wide screen), surround sound system or active noise cancellation in a premium tier, enhanced drive performance modes (driving at higher speeds, or a smoother ride), expanded luggage capacity in a premium mode, priority booking, and/or a motorcade mode, with the ability to travel in a convoy and link up vehicle communication.

Each vehicle's onboard system can also support multiple operational modes, including a standalone mode and a motorcade mode. In standalone mode, the vehicle operates as a traditional autonomous transport node in transit toward a destination location via a local GNSS feed. In motorcade mode, the vehicle becomes an active participant in a coordinated group, aligning its navigation and/or travel schedule with other vehicles according to parameters determined by the coordinated control logic 164 and/or central dispatch logic 124. Transitions between modes can occur automatically based on proximity detection, itinerary state, and/or instructions from the vehicle control system 104. For example, a vehicle may switch into motorcade mode upon detecting it has reached a designated link-up time with another vehicle, or exit motorcade mode when departing for an independent destination. The fleet vehicles can also communicate via V2V communications to synchronize integrated functions, particularly when the vehicles are within close proximity to one another.

The fleet vehicles can further support data streaming and multimedia presentation features facilitated by the vehicle control system 104 and multimedia services 106. These features can be implemented in an autonomous vehicle via a multimedia subsystem, entertainment subsystem, screen subsystem, and/or audio subsystem. One or more of these features can be activated in a premium mode, or deactivated in a standard mode. Example features can include video conferencing or messaging, synchronized entertainment between multiple vehicles (e.g., streaming movies, TV, or music, or playing games), audio settings (e.g., third-party radio or streaming services, surround sound vs. mono or standard mode, user control of sound parameters such as bass, activation of a subwoofer, etc.), and/or visual features (e.g., lighting, screen displays). The autonomous vehicles 102 within the motorcade can receive or access synchronized audio or video streams for playback through onboard display and speaker systems. The playback state may be monitored by the vehicle control system 104, ensuring that all vehicles remain synchronized within a predetermined time synchronization window. In certain implementations, vehicles may also cache pre-fetched or predictive buffers of media data, allowing playback to continue seamlessly during momentary network fluctuations. One or more vehicles in the fleet can include a library of content for playback without need to receive media data continuously;

To maintain operational integrity and participant engagement, each vehicle can log telemetry, diagnostic data, and/or session metadata. Logged data can include, for example, trip identifiers, user identifiers associated with the motorcade session (e.g., via accounts logged into end user applications), synchronization performance, media buffering statistics, and/or sensor fault information. Data can be uploaded periodically to the vehicle control system 104 for storage in secure repositories, where it can be used to refine tier configuration models, detect anomalies, or inform predictive maintenance schedules. Certain information, such as aggregated spacing and timing data, may be anonymized for privacy while still contributing to analytical models of system efficiency and performance.

Autonomous vehicles 102a-102n may also support direct integration with infrastructure services, such as charging networks, smart traffic lights, and/or venue access systems. Through the secure communication interface 144, such integrations can allow for automated charging coordination, preferred lane usage for linked fleets, or seamless check-in at destinations that recognize the motorcade as a unified group (e.g., events such as festivals or concerts partnering with the motorcade session). These external connections may operate concurrently with motorcade coordination, ensuring the vehicle's local autonomy and the system-level synchronization remain compatible.

The fleet 102 can include mixed types of vehicles (e.g., passenger cars, vans, or purpose-built pods) each with distinct cabin layouts, display configurations, and sensor packages. The motorcade vehicle control system 104 can accommodate this heterogeneity by activating or deactivating specific vehicle capabilities at the central dispatch logic 124 and/or coordinated control logic 164. This approach allows for a standardized service tier control framework capable of operating across diverse vehicle models and manufacturers.

The end-user app 118 can be executed on a user device 108 as an interface for interacting with the vehicle control system 104 and/or an autonomous vehicle 102, as a supplement to/replacement for an in-vehicle user interface device. The user device 108 may include, without limitation, a smartphone, tablet, laptop, and/or wearable computing device (e.g., smart watch). The end-user app 118 may also operate within an in-vehicle console/user interface. console. The end-user app 118 enables users to initiate motorcade sessions, manage itineraries, exchange communications, and access synchronized multimedia features. The end-user app 118 can operate with or without the use of registered user accounts. In one implementation, a user may register an account associated with a user identifier such as an email address, telephone number, username, etc. Account registration can allow the vehicle control system 104 to maintain a profile including user preferences (e.g., vehicle type, media subscription, privacy level) and historical motorcade participation records stored within a motorcade management database associated with the coordinated control logic 164. In another implementation, the app 118 may allow temporary guest access that enables participation in a specific session without full registration, using session-specific authentication tokens issued by the vehicle control system 104. In some implementations, the app 118 is accessible via a website interface to allow access without downloading an instance of the application to a mobile device. Each login or session establishment may employ multi-factor authentication to ensure secure access. The secure communication interface 144 can encrypt session credentials and token exchanges to prevent unauthorized access to motorcade data or media streams.

The end-user app 118 can provide multiple layers of interaction. At a basic level, users can view active itineraries, estimated pick-up and arrival times, and the locations of vehicles 102a-102n in near real time. The interface can display map overlays showing relative spacing of vehicles, current link-up status, and progress toward destinations. Participants can send text, voice, or video messages to other members of the motorcade. Messages are routed through the vehicle control system 104 via the secure communication interface 144, ensuring that all vehicles and users receive synchronized communication updates. The app 118 can further include media control interfaces allowing users to play, pause, or queue shared media content streamed through the multimedia services 106. These control actions can be relayed through the coordinated control logic 164, which ensures playback state consistency across all vehicles 102a-102n.

In some implementations, the end-user app 118 allows users to modify service tiers, or activate a specific premium feature, while a session is active. For example, a user may add reclining seats or video streaming during a trip. Such requests are transmitted to the vehicle control system 104, which can validate or process the request further via coordinated control logic 164 or update the configuration of the vehicle via the central dispatch logic 124. The coordinated control logic 164 can facilitate consistency and coordination within the motorcade session, ensuring that resulting timing changes remain within predefined synchronization tolerances so that group cohesion is preserved.

In some implementations, the end-user app 118 may optionally integrate with third-party services (e.g., multimedia services 106) to extend functionality. Examples include mapping and navigation APIs for alternative route visualization, calendar synchronization to automatically populate destination addresses, and/or social or event-planning platforms that facilitate coordinated group travel. The app 118 may also interface with external media streaming providers, enabling participants to link personal accounts and share playlists or media preferences within the motorcade session. In some examples, the app 118 can access event ticketing or restaurant reservation systems, allowing the vehicle control system 104 to automatically update the transportation itinerary based on confirmed event start times or reservation windows. Similarly, integration with payment systems can enable cost-sharing or per-seat billing models among participants. These 3^{rd}-party connections are managed through secure application programming interfaces (APIs) or OAuth-based authorization frameworks, ensuring that external data exchange does not compromise the integrity or privacy of the motorcade session. In some implementations, the end-user app 118 maintains local copies of session metadata (e.g., participant identifiers, timing parameters, payment data, and recent communication history) to provide continuity during temporary network loss. When connectivity resumes, the vehicle control system 104 can reconcile local and central session states using timestamps and event sequence identifiers to prevent duplication or data loss.

In some implementations, privacy controls are available within the app 118, allowing users to determine the extent of data sharing with the vehicle control system 104 and other participants. A user may, for instance, disable live location broadcasting while still participating in group communications or allow their identity to appear anonymously within shared media interactions. The secure communication interface 144 enforces encryption of personal data and session communications, while the vehicle control system 104 enforces data retention and deletion policies consistent with privacy preferences configured through the app 118. In some implementations, the end-user app 118 may include a “guest mode” feature that allows a non-registered participant to temporarily view navigation progress or receive updates about a motorcade without accessing full communication or control functionality. This feature can be useful for event coordinators or external observers wishing to monitor arrival status of a group, or participants that do not have mobile access or cannot create user accounts (e.g., children, international travelers without cellular service, etc.).

The system 100 can operate through a structured data exchange architecture linking the vehicle control system 104, the fleet 102 of vehicles, the end-user app 118 executed on one or more user devices 108, and any connected multimedia services 106. Vehicle control system 104 can communicate with autonomous vehicles 102a-102n over the secure communication interface 144, which manages bidirectional data streams across one or more networks. In some implementations, the communication interface can adaptively select among connection types (including cellular, satellite, Wi-Fi, or dedicated short-range radio) based on measured link quality and function priority. For example, control data related to vehicle spacing or safety-critical updates may be routed over a resilient cellular link, while multimedia data may be streamed through broadband Wi-Fi or pre-buffered during high-bandwidth availability. The vehicle control system 104 can aggregate incoming vehicle data from one or more of the vehicles 102a-102n, such as location, velocity, orientation, and/or sensor health metrics derived from their respective camera systems 122. This data can be further timestamped, logged, and processed by the coordinated control logic 164 to generate a unified model of the motorcade in some implementations. The resulting model can allow the server to issue real-time or near-real-time synchronization commands to each vehicle, adjusting parameters such as route segment timing, spacing intervals, and lighting display cues to preserve coordination.

While the vehicle control system 104 maintains overarching coordination, vehicles 102a-102n may also exchange data directly through peer communication channels to support local responsiveness and reduce dependence on the central network, e.g., P2P and V2V communication. These links may be established using dedicated short-range communication (DSRC), 5G sidelink, ad-hoc Wi-Fi, or other vehicle-to-vehicle (V2V) protocols. In one implementation, vehicles 102 can leverage peer channels to broadcast compact state packets containing relative position, heading, and speed data. For example, when vehicle 102a decelerates, it can transmit a short-range notification to trailing vehicles 102b and 102c, allowing immediate local adjustments prior to propagation through the vehicle control system 104. The peer network may also support synchronization of lighting patterns or in-cabin media triggers where minimal latency is desirable. To ensure consistency across the system, each vehicle may periodically verify that its peer-network state remains aligned with the global session state maintained by the vehicle control system 104 in certain implementations of the technology disclosed. A deviation from the transportation itinerary, such as a timing drift outside the defined time synchronization window or a route deviation forced by traffic flow controls, can prompt automatic recalibration by the coordinated control logic 164, restoring consistency without requiring user intervention.

The end-user app 118 can communicate with the vehicle control system 104, using encrypted application-layer protocols that operate independently of the vehicle-server communication layer. The secure communication interface 144 can manage both vehicle-server communication and user communication, ensuring consistent encryption and access control policies across channels. Through this interface, user devices 108 can exchange itinerary data, control inputs, and event notifications with the central dispatch logic 124. For example, when a participant modifies a service tier or premium feature activation in the end-user app 118, the vehicle control system 104 can evaluate the requested modification, update the reconfiguration data, and transmit the reconfiguration data to the vehicles 102a-102n through the central dispatch logic 124 and secure communication interface 144. Conversely, when a vehicle reports a timing deviation or environmental hazard, the vehicle control system 104 can transmit updated information to user devices 108 so that participants see live adjustments reflected in the application interface.

Data from the end-user app 118 may also include control inputs for comfort or performance features relating to media playback, communication session initiation, or lighting customization, all of which are routed through the vehicle control system 104 to facilitate reconfiguration of the vehicle. The vehicle control system 104 can interface with one or more multimedia services 106 to manage content delivery, buffering, and playback synchronization across the motorcade. This connection may use cloud-based APIs or secure streaming endpoints that provide adaptive bitrate data streams. The coordinated control logic 164 monitors playback progress and alignment between vehicles 102a-102n, issuing micro-adjustments to buffer offsets or playback rate so that all participants experience synchronized content within the active time synchronization window. The multimedia services 106 can also supply metadata, such as lyrics, visualizations, or ambient lighting themes, which are transmitted through the vehicle control system 104 to the vehicles'multimedia presentation systems. The vehicle control system 104 may employ predictive prefetching, storing upcoming media segments in the local caches of vehicles 102a-102n based on the itinerary's remaining duration or expected network quality along the route. This approach enables continuous playback during periods of reduced connectivity while still maintaining unified timing when network conditions improve. It also can access on onboard library of content.

The various communication paths in motorcade system 100 can contribute to a multi-tiered feedback loop that maintains operational consistency and enables learning-based system improvement. The vehicle control system 104 can log coordination data, timing adjustments, and/or user-initiated actions into a structured event log. Vehicles 102a-102n may also record local event histories, including timestamps of received synchronization commands or communication latency statistics. Periodically, these local logs can be uploaded to the vehicle control system 104 for integration into global session analytics. Analysis of past sessions may be used to train optimal parameters for link-up spacing, enabling the coordinated control logic 164 to adjust thresholds dynamically during future operations.

During an active session, the coordinated control logic 164 can operate as a central arbitration layer to process and evaluate incoming data related to integrated feature(s) across the motorcade. Data from vehicles 102a-102n and user devices 108 flows into the vehicle control system 104 via the secure communication interface 144, where it is aggregated, analyzed, and/or transformed into control data via the coordinated control logic 164. The updated data and/or controlled data can then be transmitted back through the secure communication interface 144 (potentially after further processing via the central dispatch logic 124) to the vehicles 102 and/or user devices 108, closing the control loop.

FIG. 2 is a block diagram of an autonomous vehicle 102 in accordance with one implementation of the technology disclosed. Autonomous vehicle 102 includes a camera system 112 (including at least one camera and at least one LiDAR), an onboard processor, an E2E model 122, communication logic 132, a screen subsystem 142, a seat subsystem 152, a drive mode subsystem 162, a sound subsystem 172, and a luggage subsystem 182. Autonomous vehicle 102 can also include a lighting display 202 (internal and/or external lighting) and at least one user interface 222.

The camera system 112 represents the ensemble of sensors used to perceive the environment surrounding the vehicle 102. It may include 2D or 3D cameras, LiDAR, radar, GNSS, and/or inertial sensors. In most implementations, camera system 112 includes at least one camera and at least one proximity sensing device. Data from these sensors can be fused locally to provide continuous estimates of vehicle position, speed, and environmental context. Sensor data is also transmitted to the vehicle control system 104 through the communication logic 132 to contribute to intervehicle fleet navigation. The sensor data is provided as input, along with driving route navigation data, to E2E model 122, described in further reference with respect to FIG. 3.

Each vehicle 102 can include an entertainment system including, or linked to, communication logic 132, sound subsystem 172, and/or screen subsystem 142. Media, such as videos, images, and graphical user interfaces can be presented to a user via screen subsystem 142. Screen subsystem 142 can include at least one user interface 222, such as a touch screen display. Various features of the screen subsystem can be activated or deactivated at different service tiers. For example, a deactivated feature may be locked out such that it is not available to a user riding in the vehicle at the selected service tier. In some implementations, the user may be able to request additional features mid-service, e.g., via payment, promotion, trial, subscription, etc. Screen subsystem 142 features can include an activatable touch screen, an activatable media viewing service such as movie streaming or web browsing, or a variable size viewable screen area. Sound subsystem 172 features can include access to various audio sources (e.g., basic AM/FM radio, ability to connect a user device via aux, USB, or Bluetooth, or third party services like SiriusXM or Spotify), an activatable feature allowing a user to modify the sound mixing parameters (e.g., bass, treble, balance), sound upgrades (e.g., mono to surround sound), external noise cancellation, or activation of additional audio system components like a subwoofer. A library of content may be accessible, including premium content.

Additional entertainment features that can be activated or deactivated in various service tiers may include video conferencing (via communication logic 132, screen subsystem 142, and sound subsystem 172), messaging with other vehicles (via communication logic 132, screen subsystem 142), or audio calling (via communication logic 132, sound subsystem 172). Additional user experience features that can be activated or deactivated in various service tiers may also include access to Wi-Fi, higher data limits, or higher speed connections via communication logic 132. Additional user experience features that can be activated or deactivated in various service tiers may include access to games or interactive experiences via communication logic 132, screen subsystem 142, and sound subsystem 172. More user experience features that can be activated or deactivated in various service tiers may include customization of aesthetic features, such as the internal and/or external lighting display 202 (e.g., changing colors, patterns, messaging or other displayed content, synchronization with other vehicles in a motorcade, and so on). Other activatable features are discussed further with respect to FIGS. 4 and 5.

In a motorcade mode, the communication logic 132, screen subsystem 142, and/or sound subsystem can provide presentation of media content via a display of one or more user interfaces 222 to provide immersive, interactive, and coordinated experiences among participants across the motorcade. Communication logic 132 can manage content reception, synchronization, and playback, while the screen subsystem 142 provides a human-machine interface for passengers to engage with navigation data, communication tools, and/or shared entertainment features. Communication logic 132 can receive media streams directly from the server 104, screensharing from user devices 108, or stream media content obtained through a multimedia service 106, such as content delivery networks, streaming platforms, or hosted media libraries. Content may include audio, video, live broadcasts, or interactive applications. For example, during a group travel session, the vehicle control platform 104 may stream synchronized video content across all vehicles 102a-102n, such as a concert recording, movie, or live sports event. Passengers may view the content on displays associated with the screen subsystem 142, such as user interface 222. The playback state of a video stream (e.g., controlled through user commands such as play, pause, rewind, fast forward, change volume level, or change media content to a different stream) may be controlled collectively across the motorcade or individually. The communication logic 132 can implement adaptive buffering such that playback remains continuous across vehicles even under variable network conditions, with fine-grained synchronization maintained within the designated time synchronization window. In some implementations, media content playback is synchronized between vehicles via V2V communication channels.

The user interface 222 and communication logic 132 can further facilitate a wide range of communication features and group interactions. Passengers can send chat messages, voice memos, pictures, or videos that are shared across vehicles 102 in the motorcade through the communication logic 132, and in some implementations, vehicle control system 104. In some implementations, a passenger of a 1^{st} autonomous vehicle 102a can send a private message to one or more specific autonomous vehicles (e.g., only 102b, or only 102b and 102c) without making the message accessible to the rest of the motorcade. In such implementations, the vehicle control system 104 can facilitate distribution of message content to the appropriate recipients via respective communication logic 132. In some implementations, the interface may include an activatable “group intercom” feature supporting live or push-to-talk communication between vehicles, allowing participants to join voice channels organized by topic or by vehicle groupings. For enhanced engagement, cross-vehicle video conferencing may be supported, wherein a specific user interface 222 displays tiled video feeds from other vehicles, wherein synchronized audio-visual timing is managed via the vehicle control system 104. Participants may also interact through real-time polls, gestures, or visual reactions that are rendered simultaneously across vehicles, creating a shared, event-like atmosphere within the motorcade.

Beyond passive playback, the activatable comfort features can deliver interactive or augmented media experiences via communication logic 132, screen subsystem 142, and/or sound subsystem 162. Passengers may participate in synchronized trivia games, collaborative playlists, or location-based augmented-reality challenges that evolve as the motorcade progresses along its route. The external and/or internal lighting displays 202 may respond dynamically to these interactions (for instance, pulsing in rhythm with music or shifting color palettes based on visual cues) thereby creating a unified multisensory environment across all vehicles 102a-102n in the motorcade session. In some implementations, the communication logic 132 may connect with personal mobile devices 108 or wearables (e.g., Bluetooth headphones or earbuds), allowing a passenger to use a smartphone as a secondary controller for playback, volume, or gesture-based lighting adjustments.

The user interface 222 can also provide access to motorcade management features, enabling passengers to interact directly with navigation and coordination functions, as well as comfort or performance features. For example, users may view the activated features in premium mode within a service tier, interact with activated features, or request activation of certain features during an active session. Depending on current usage conditions, the vehicle control system 104 may allow activation of certain features mid-service (e.g., activating WiFi) or deny activation of other features for safety or feasibility reasons (e.g., luggage space not expandable when the quantity of seats provided for users exceeds a certain maximum, such as a 6 seat vehicle that must collapse seats to expand storage). The interface may also allow initiation of link-up events in a motorcade convoy, in which one or more vehicles converge mid-trip, by transmitting a motorcade update request that prompts the server 104 to issue updated link-up coordinates and timing directives. Passengers can select formation styles, such as staggered or linear arrangements, and activate proximity-based behaviors where sound or lighting effects adjust dynamically when vehicles draw within a defined spatial threshold. In some implementations, users can customize “nicknames” for respective vehicles 102 and/or passengers thereof within the motorcade for display throughout the motorcade session.

Some implementations involve activatable service features in which connections to social media services may permit live sharing or status updates from within the motorcade, in accordance with privacy settings enforced by the vehicle control system 104. Navigation or mapping service integrations can augment in-vehicle displays with live traffic overlays or predictive arrival estimates. In certain implementations, the user interface 222 may include selectively activatable voice-activated digital assistants that interpret commands such as “extend the playlist for another 20 min.,” “invite the motorcade to our video call channel,” or “update destination to a restaurant near the concert hall.” These commands may be processed locally or routed to the server 104, where the central dispatch logic 124 and coordinated control logic 164 can interpret and implement said commands accordingly.

Customization, accessibility, and safety considerations are also supported by many implementations of the technology disclosed. The user interface 222 may adapt to passenger preferences or accessibility needs, providing high-contrast modes, voice narration, and/or gesture-based controls for users. Administrative configurations can restrict specific functions, such as disabling external communications or limiting certain media categories. Certain service tiers may further include a “quiet mode,” which mutes group communications while maintaining coordination and system updates, or a “focus mode,” which emphasizes navigation and timing information during complex link-up maneuvers or route transitions.

Subsystems of vehicle 102 and vehicle control system 104 may collectively enable a flexible, multi-layered interaction framework for interaction that unifies entertainment, communication, and navigation under coordinated control by the server 104. Through integration of real-time media, communication, and control capabilities, the system provides socially connected and dynamically adaptive group travel experiences that extend beyond the capabilities of traditional rideshare or in-vehicle infotainment systems.

The discussion now turns to a detailed explanation of the autonomous driving capabilities of autonomous vehicle 102, followed by further discussion of the selectively activatable comfort or performance features.

### End-to-End Autonomous Driving Model

FIG. 3 is an architectural-level schematic of end-to-end autonomous driving model 122, including an end-to-end conditional imitation learning model 301 for autonomous driving. Conditional imitation learning model 301 is illustrated within FIG. 3 in accordance with one exemplary implementation of the technology disclosed comprising a transformer architecture. At a high level, the conditional imitation learning model 301 processes environmental data corresponding to a state s₀ 302 within a driving environment to prescribe an appropriate response action 324. The prescriptive response action can include actuation of the steering wheel and accelerator/brakes that change the speed 324a, orientation 324b, and thus, location 324c of the vehicle.

Input state s₀ 302 is represented by observations including an image 302a and a plurality of non-camera environmental data 102b (e.g., LiDAR and GNSS data). In addition to the observations describing state s₀ 302, a directive condition 302c (e.g., a GPS-direction guiding a vehicle along an intended route) is also provided in certain implementations. Hence, conditional imitation learning model 301 predicts an action (e.g., braking) in response to a state (e.g., rapidly approaching the rear of another vehicle). In another implementation, the conditional imitation learning model 301 predicts an action (e.g., steering the vehicle to the right) in response to a state (e.g., approaching an intersection with another perpendicular street).

In addition to the data corresponding to the present state s₀ 302, memory data in a compressed format is extracted from storage in a frame buffer containing information corresponding to a number of prior states in the given trajectory. For simplicity and clarity, FIG. 3 illustrates a total of 5 previous memory frames 322, 342, 362, 382, and 392. In other implementations of the technology, more than 5 previous memory frames are stored in the frame buffer such as 10, 15, 20, or more previous memory frames. These memory frames may cover 2, 3, 5 or more seconds of history at frame rate lower than standard video capture.

Prior to the 2^{nd} processing stage performed by conditional imitation learning model 301, observation data for state s₀ 302 undergoes pre-processing in a 1^{st} stage processor stage by pre-processor module 303. Pre-processor 303 embeds the respective input data from image 302a, non-camera environmental data 302b, and directive condition 302c. In some implementations, image 302a undergoes image processing that is unique to the deep learning analysis of image data, as indicated by the hashed-line shading of the unit within pre-processor 303 adjacent to image 302a. In certain implementations, this image processing is performed by a convolutional neural network. In some implementations, the pre-processing of image 302a, or other spatial mapping data (e.g., LiDAR data), involves generation of positional embeddings that maintains the integrity of the location information corresponding to the data.

After pre-processing, the processing stack, comprising conditional imitation learning model 301, processes the embedded outputs from pre-processor 303 along with the compressed memory states 322, 342, 362, 382, and 392 using a transformer 304 and compression layer 306. The compression layer 306 of the illustrated processing stack produces the memory frame for input state s₀ 302. In other words, the output of compression layer 306 is a compressed memory state 308 of input state s₀ 302. Compressed memory state s₀ 308 will be stored within the frame buffer using a FIFO (1^{st} in, 1^{st} out) storage process such that at the time of processing a state s₁, the frame buffer will include compressed memory representations 308, 322, 342, 362, and 382 respective to states s₀, s₋₁, s₋₂, s₋₃, and s₋₄. To generate the predicted response action 324 in response to input state s₀ 302, compressed memory state s₀ 308 is processed in the 2^{rd} stage processor by a classification head 310 to generate the prescriptive response action 324. Specifically, the compressed memory state s₀ 308 is processed to produce actuation of the steering wheel and accelerator/brakes that can change the speed 324a, orientation 324b, and thus, location 324c of the vehicle.

### Comfort and Performance Features

A brief overview of how reconfiguration data can be used to alter the configuration of various comfort or performance features, implemented by subsystems of a vehicle 102, will be presented followed by examples of vehicle subsystems and related comfort or performance features with respect to FIGS. 4-5. The technology disclosed can include communication logic 132 within a vehicle 102 that interfaces with vehicle control system 104 over a secure communication channel to configure and reconfigure tiers of comfort and performance features across an autonomous vehicle fleet. In many implementations, the vehicle control system 104 executes algorithms for tracking demand across a service region, analyzing ride requests received from user devices and identifying requested service tiers such as standard, comfort, or premium. Based on this data, the vehicle control system 104 can determine an allocation of vehicles between the available tiers, considering factors such as proximity of specific vehicles to requesting users, current utilization levels, and predicted short-term demand patterns such as over 30 minutes, an hour, three or four hours, or a day or any range among these durations. The control system then transmits the reconfiguration data to one or more particular vehicles 102a-102n, including commands to relevant subsystems of said particular vehicles 102a-102n, via a secure communication interface. Within each vehicle 102a-102n, a local communication logic 132 receives the transmitted reconfiguration data, may optionally authenticate the command, and interfaces with one or more onboard subsystems to adjust the activation state of features associated with the onboard subsystems according to the assigned tier. The communication logic 132 can further reports status confirmations and updated user request data and environmental data (e.g., traffic conditions) back to the vehicle control system 104, completing a closed-loop exchange that allows the central system to verify successful reconfiguration and continuously refine tier allocations in real time.

In some implementations, the onboard communication logic 132 incorporates a secure communication interface 522 configured to maintain authenticated, low-latency links with the vehicle control system 104 and other authorized devices within the fleet network. Each session established between the vehicle 102 and the vehicle control system 104 can employ mutual authentication and encryption, e.g., using token-based authentication protocols such as OAuth 2.0 or certificate-based TLS handshakes. Once a secure session is established, the communication interface 522 manages encrypted data channels for transmitting reconfiguration data and status data, ensuring that configuration commands cannot be intercepted or altered in transit. To reduce latency and maintain responsiveness during fleet-wide reconfiguration events, the communication logic may offload certain processing tasks to an edge controller within the vehicle. The edge controller can perform local validation, caching of recent configuration data, and prioritized message queuing to allow the vehicle 102 to respond to configuration commands in near real time, even when network connectivity fluctuates. Periodic synchronization messages between the vehicle 102 and the control system 104 can help to ensure that tier assignment, subsystem status, and operational metrics remain consistent across all nodes of the fleet. The resulting distributed, security-hardened communication framework ensures that large-scale dynamic tier configuration can occur safely, reliably, and within latency thresholds suitable for continuous operation of autonomous vehicles.

FIG. 4 is a block diagram of example comfort and performance features. In one example implementation, a seat subsystem 152 may control one or more vehicle seats 402. Vehicles 102 in the fleet may include up to 6 seats that can be collapsed, e.g., for additional luggage space when not in use. Additional selectively activatable features can include seat recline, leg room, lumbar support, massage, seat cooling, or seat heating. One or more of these features may be activated in a premium mode and deactivated in a standard mode. In another example implementation, a screen subsystem 142 may control one or more screens, e.g., user interfaces 222 comprising a display. Selectively activatable features can include a larger accessible screen area (e.g., expanding to use more of the available display), touch screen access, viewing options (e.g., activating 1080p or 4K mode), or interactive features (e.g., connecting to communication or multimedia content). One or more of these features may be activated in a premium mode and deactivated in a standard mode.

In another example implementation, a drive mode subsystem 162 may control one or more components associated with drive performance mechanics 422. Features can include various drive modes, such as a standard mode, eco mode, sport mode, or comfort mode. For example, suspension or gear shift parameters may be adjusted in comfort mode for a smoother ride, or sport mode for better performance at a higher speed or sharper turns. In an eco mode, the vehicle may alter parameters related to engine idle, acceleration, turning off high power usage user features, and/or opting for more eco-friendly navigation routes. One or more of these features may be activated in a sport mode or comfort mode, and deactivated in a standard mode. Eco mode may also include a ridesharing feature, where multiple users with similar routes or end destinations share the same vehicle. For example, users may receive a discount or a ride credit if they elect to opt into eco mode.

Some implementations include a sound subsystem 172 that controls one or more audio components 424, e.g., radios, speakers, or subwoofers. Selectively activatable features can include surround sound mode, connectivity to user devices via aux cord, USB, Bluetooth, etc., noise cancellation, or access to music libraries and/or streaming services. One or more of these features may be activated in a premium mode and deactivated in a standard mode. A standard mode might have limited audio functionality, with one or more of the above features locked out. For example, one standard service tier that does not include premium audio can be limited to AM/FM radio in mono or stereo mode on the basic speaker system, without access to additional music services, sound quality services, or advanced audio output devices.

FIG. 5 is a block diagram of additional example comfort and performance features. Some implementations include a luggage subsystem 182 that controls one or more storage space areas 502, e.g., trunks or in-cabin storage. Selectively activatable features can include expandable space. In one example implementation, the autonomous vehicle 102 has a rear trunk and a front trunk, and premium mode may involve unlocking access to one or both storage spaces. In other example implementations, the storage space can include a mechanical partition that the luggage subsystem 182 can electronically move to expand or constrain the available space in response to reconfiguration data from the vehicle control system 104. In another example implementation, the vehicle 102 has one or more seats that can be collapsed (e.g., a row that lays flat) to make additional space for luggage. The vehicle control system 102 can transmit reconfiguration data to the vehicle 102 that includes instructions for the seat subsystem 152 and luggage subsystem 182 to reconfigure which seats are activated and which seats are deactivated in order to activate expanded luggage space. In another example, the configuration of a particular luggage space can be reconfigured to various premium organization modes, e.g., to include more horizontal or vertical storage, to support fragile items, to keep items temperature controlled, or various structures such as shelving or bins. One or more of these features may be activated in a premium mode and deactivated in a standard mode.

In another implementation, the vehicle comprises an entertainment subsystem 504 that interfaces with the screen subsystem 142 and/or communication logic 132 to provide additional entertainment features via user interfaces 222, such as displays (e.g., a screen designed for displaying viewable content, a touchscreen designed for receiving user input, or a hybrid thereof capable of reconfiguration to allow different inputs, present different types of content, or enable different sizes of screen area and/or maximum resolution compatibility), user input devices (e.g., tablets, controllers, or linked user devices associated with the passengers), the sound subsystem 172, etc. Selectively activatable features can include audio calls, text messaging, video conferencing, displaying video, playing music, presenting games and interactive content, and/or interfacing with user devices. Said selectively activatable entertainment features can use multimedia content libraries, locally-stored content, screen mirroring with user devices, audio connections to user devices or integration of user devices such as via Apple CarPlay, streaming content, and third-party applications. Users may further select to activate connectivity, such as WiFi or cellular access. Connectivity can be tiered by speed (e.g., high-speed connectivity versus basic connectivity), data usage (e.g., a maximum data upload or download limit), or length of time (e.g., activating WiFi for a set time window, for the entire ride, for a full day, etc.). The entertainment subsystem 504 can further include activating or deactivating outlets (further including connectors like USB charging ports or contact-based charging like MagSafe) or adjusting the wattage limit such that premium mode raises the accessible power of the outlets up to 80 watts, 100 watts, 120 watts, 150 watts, or any other value within a range bounded by two of these values. In contrast, a standard mode can limit the quantity or type of outlets/ports available, and/or limit the accessible power up to 15, 20, or 30 watts, or any other value within a range bounded by two of these values. The entertainment subsystem 504 may also control selectively activatable connectivity features like Bluetooth, USB, or aux connection to user devices.

Many implementations include a communication logic 132 of vehicle 102 that interacts with a secure communication interface 522. Secure communication interface 522 can connect to the vehicle control system 104 (e.g., via communication interface 144 of vehicle control system 104, discussed further below) or using edge communication for V2V communication. In a motorcade or fleet, vehicles 102 can continuously exchange data with the control system 104 and one another for configuration and coordination purposes, as previously discussed with respect to FIG. 1. For example, vehicle control system 104 transmits data and receives data from communication logic 132 involved in the reconfiguration of vehicles to allocate vehicles between service tiers and to selectively active a particular feature in a particular vehicle. The vehicle control system 104 may also transmit data and receive data from communication logic 132 to monitor and update navigation data as necessary, as discussed in further detail with respect to FIG. 6. Vehicles may also communicate with one another over the secure communication interface 522 as a low latency communication option for synchronization or reconfiguration.

### Motorcade Mode

The discussion now turns to a detailed discussion of disclosed operations for coordinated control of integrated navigation during a motorcade session with respect to various example implementations. FIG. 6 shows a message flow diagram 600 for coordinated control of navigation features across a motorcade including server 104, autonomous vehicle 102a, and autonomous vehicle 102b. Following generation of a transportation itinerary including driving routes and estimated travel schedules by the central dispatch logic 124 (not explicitly shown in FIG. 6), the secure communication interface 144 of the server transmits the transportation itinerary to autonomous vehicle 102a in operation 602a, and to autonomous vehicle 102b in operation 602b.

Upon receipt, the secure communication logic 162 of each vehicle provides the itinerary data to the vehicle's E2E autonomous driving model 142. Specifically, autonomous vehicle 102a receives the itinerary in operation 603a, and autonomous vehicle 102b receives the itinerary in operation 603b. Each E2E model 142 generates actuation signals for steering, acceleration, and braking by processing both the itinerary data (from operations 603a/903b) and input driving data obtained from respective camera systems 122. The camera system 112 of vehicle 102a provides driving data in operation 604a, while the camera system 112 of vehicle 102b provides corresponding data in operation 604b.

As each vehicle gathers new driving data, the secure communication logic 162 packages and transmits relevant metrics to the server 104 via the secure communication interface 144, enabling cross-vehicle coordination. For example, autonomous vehicle 102b may detect a change in navigation context, such as unexpected congestion, a construction zone, or deviation from estimated timing, and transmit updated navigation data to the server 104 in operation 608.

The secure communication interface 144 passes the updated data to the coordinated control logic 164, which processes the input in operation 610 to determine whether adjustment of the motorcade itinerary is warranted. Such an adjustment may involve re-routing another vehicle to avoid a developing slowdown, or modifying spacing to maintain synchronized arrival. When the coordinated control logic 164 determines that the transportation itinerary requires updating, it transmits the processed data to the central dispatch logic 124.

In operation 612, the central dispatch logic 124 updates the transportation itinerary based on the received navigation data, recalculating routes and travel times as appropriate. The updated itinerary is then returned to the secure communication interface 144 in operation 613, which in turn transmits the revised itinerary to autonomous vehicle 102a. The secure communication logic 162 of autonomous vehicle 102a delivers the updated itinerary to its E2E model 142 in operation 615, prompting corresponding adjustments to the local navigation plan.

Some implementations further include a Superfan Motorcade mode. A group of individuals spread out across multiple locations (e.g., at their respective homes or places of work) that are all attending the same event can book a Superfan Motorcade to pick up passengers at each respective location with synchronized arrival times at the event destination. Each pick-up address is provided for the corresponding group members when booking a Superfan motorcade. The system will calculate the estimated travel time from each of the various addresses to the event destination and coordinate pick-up times such that all vehicles in the motorcade arrive at the event destination at approximately the same time. Hence, each passenger is provided with a pick-up time based on the estimated travel time from their pick-up location so that the group can arrive at the event at, or near, the same time. In some implementations, the system adjusts a driving route for at least one vehicle within the motorcade in order to converge routes with other vehicles in the motorcade enroute so that the motorcade vehicles travel together, substantially similarly to the described synchronized travel of other implementations disclosed herein.

In one implementation, the Superfan Motorcade is provided as an API that can be integrated with other services. For example, a VIP ticket package to a concert can include Superfan Motorcade travel to the event for a group of attendees.

The technology disclosed allows for coordination of service tier via multi-vehicle control. For premium services, the vehicle control system 104 can coordinate multiple vehicles to form a motorcade, synchronize external lighting across the motorcade, and/or link internal audio and video systems between vehicles. Motorcade mode provides several advantages over existing ride-sharing systems, including increased fleet utilization and efficiency, enhanced service flexibility and responsiveness to market demand, improved customer experience across multiple price points, reduced costs associated with maintaining multiple vehicle types, ability to quickly adapt to changing market conditions and customer preferences, etc.

By enabling a single vehicle platform to serve multiple market segments through dynamic feature activation and deployment, this system significantly enhances ride-sharing network liquidity and operational efficiency.

### Example Mechanisms for Feature Activation/Deactivation

The system employs multiple user interfaces for feature activation/deactivation. These features can be implemented as separate programs, as add-ons to or scripts running on web browser, and as apps that wrap browser-lie approaches. Examples of user interfaces, in addition to those presented above, include:

### a) Mobile Application:

Native iOS and Android apps with intuitive UI for feature selection
Real-time updates using WebSocket protocol for instant feature toggling

### Alternatives:

Flutter/Dart cross-platform app with Server-Sent Events (SSE)
React Native app with Socket.IO
Progressive Web App (PWA) with Long Polling

### b) In-Vehicle Kiosk:

Touchscreen interface with haptic feedback
Voice-activated controls using natural language processing

### Alternatives:

Dial/knob interface with force feedback, gesture recognition with computer vision
Pressure-sensitive buttons with LED feedback, eye-tracking with AI processing
Multi-touch display with thermal feedback, brain-computer interface (BCI) controls

### c) Web Interface:

Responsive design for access across devices
RESTful API for seamless integration with the central system

### Alternatives:

Adaptive design with GraphQL endpoints
Mobile-first design with gRPC services
Fluid design with WebSocket API

### d) Voice Control:

Integration with popular voice assistants (e.g., Siri, Google Assistant)
Custom wake words for direct system interaction

### Alternatives:

Alexa/Cortana integration with customizable voice commands
Bixby/Dragon integration with voice biometrics
Custom voice assistant using Mozilla DeepSpeech with personalized models

### e) Hand Gesture Recognition:

In-vehicle cameras with computer vision algorithms for gesture detection
Predefined gesture set for common feature toggles

### Alternatives:

Radar sensors with machine learning for 3D gesture tracking
Infrared depth sensors with skeletal tracking
Ultrasonic sensors with motion pattern recognition

### Example Algorithms for Demand Sensing and Dynamic Configuration and Deployment

The system can utilize cloud-based AI with machine learning predictive models or local models deployed and updated from the cloud. Examples of AI models that can readily be adapted for demand sensing, dynamic configuration, and demand prediction include:

### a) Demand Sensing:

Time series analysis using ARIMA models for short-term forecasting
Long Short-Term Memory (LSTM) neural networks for capturing long-term patterns
Integration of external data sources (weather, events, traffic) using ensemble methods

### Alternatives:

Prophet for short-term, Transformer networks for long-term, stacking ensemble
SARIMA for short-term, GRU networks for long-term, voting ensemble
VAR for short-term, Temporal Fusion Transformers for long-term, boosting ensemble

### b) Dynamic Configuration and Deployment:

Reinforcement learning algorithm (e.g., Deep Q-Network) for price optimization
Multi-armed bandit approach for exploring configuration and deployment strategies
Real-time adjustment using sliding window analysis of current demand and supply

### Alternatives:

Proximal Policy Optimization (PPO), Thompson Sampling, exponential smoothing
Advantage Actor-Critic (A2C), UCB1 algorithm, moving average convergence
Soft Actor-Critic (SAC), Epsilon-greedy, adaptive window analysis

### c) Predictive Model:

Gradient Boosting Machines (e.g., XGBoost) for feature importance and prediction
Regular retraining schedule with A/B testing for model updates
Anomaly detection using Isolation Forests for identifying unusual demand patterns

### Alternatives:

LightGBM with multi-armed bandit testing, Local Outlier Factor (LOF)
CatBoost with canary testing, One-Class SVM
H2O AutoML with champion-challenger testing, DBSCAN clustering

### Example Hardware Specifications for System Components

The system interfaces with various IoT devices for user interaction. Examples of devices that could be used is given below. Many alternative devices can be used. Example devices include:

### a) Mobile Devices:

Compatibility with iOS 12+ and Android 8+
Bluetooth Low Energy (BLE), previous and subsequentially developed wireless protocols for proximity-based feature activation

### Alternatives:

HarmonyOS and Windows Mobile with NFC
KaiOS and FireOS with UWB (Ultra-wideband)

### b) In-Vehicle Kiosk:

10-inch capacitive touchscreen with 1920×1200 resolution or a large or smaller screen
Embedded system with 4 GB RAM, 64 GB storage; option to user additional RAM and storage
4G LTE modem for constant connectivity; option for switching to 5G and later standards when signal is reliable in those bands

### Alternatives:

12-inch resistive touchscreen, 8 GB RAM, 128 GB NVMe storage, 5G modem
8-inch OLED touchscreen, 6 GB RAM, 32 GB eMMC storage, Wi-Fi 6+LTE

### c) Web Terminals:

Support for modern browsers (e.g., Chrome, Firefox, Safari, Edge)
Progressive Web App (PWA) capabilities for offline functionality

### Alternatives:

Opera, Brave, Vivaldi with offline caching
Tor Browser, Chromium, Pale Moon with service worker support
Samsung Internet, UC Browser, DuckDuckGo with WebAssembly support

### d) Voice Control Systems:

Far-field microphone array with noise cancellation
DSP chip for local voice processing to reduce latency

### Alternatives:

MEMS microphones with beamforming, FPGA for audio processing
Close-talk microphones with acoustic echo cancellation, ARM audio coprocessor
Linear microphone arrays with adaptive noise reduction, dedicated audio SoC

### e) Gesture Recognition:

Wide-angle camera (120° field of view) with infrared capabilities
Dedicated GPU for real-time image processing

### Alternatives:

Time-of-Flight (ToF) sensor with 90° FOV, FPGA for processing
Stereo camera system with structured light, Edge TPU for processing
Depth-sensing camera with 140° FOV, Neural Processing Unit (NPU)

### Example Software Architecture for Integration

Cloud-based architecture components that connect with the various IoT devices can be built on a variety of platforms. One example of platforms that could be used is given below. Many alternative platforms can be used, such as a Time-of-Flight (ToF) sensor with 90° FOV, FPGA for processing; a stereo camera system with structured light, Edge TPU for processing or a depth-sensing camera with 140° FOV, Neural Processing Unit (NPU).

Example platforms include:

a) Backend example platforms:
Microservices architecture, for instance deployed on Kubernetes
Event-driven design for real-time data streaming, for example using Apache Kafka
GraphQL API gateway for efficient data fetching

### Alternatives:

Docker Swarm with RabbitMQ and REST APIs
Amazon ECS with Apache Pulsar and gRPC
OpenShift with NATS messaging and SOAP APIs
   b) Data Storage example platforms:
PostgreSQL for transactional data
MongoDB for unstructured data and user profiles
Redis for caching and real-time feature states

### Alternatives:

MySQL, CouchDB, Memcached
MariaDB, Cassandra, Aerospike
CockroachDB, RavenDB, Hazelcast
   c) Machine Learning Pipeline example platforms:
TensorFlow serving for model deployment
Kubeflow for ML workflow orchestration
Feature store using Feast for consistent feature engineering

### Alternatives:

ONNX Runtime, MLflow, Hopsworks
Triton Inference Server, Apache Airflow, Redis Feature Store
   d) IoT Integration example platforms:
MQTT protocol for lightweight communication with vehicles
AWS IoT Core for device management and security

### Alternatives:

CoAP protocol, Azure IoT Hub
AMQP protocol, Google Cloud IoT Core
Edge computing nodes in vehicles for low-latency operations
   e) Security example platforms:
OAuth 2.0 with JWT for authentication and authorization
End-to-end encryption for all data transmissions
Regular penetration testing and vulnerability assessments

### Alternatives:

OpenID Connect with SAML tokens, TLS 1.3 encryption
PKCE with Macaroons, homomorphic encryption
FIDO2/WebAuthn with session tokens, quantum-resistant encryption
   f) Monitoring and Logging example platforms:
ELK stack (Elasticsearch, Logstash, Kibana) for log management
Prometheus and Grafana for real-time system monitoring
Distributed tracing using Jaeger for performance optimization

### Alternatives:

Splunk, Datadog, Zipkin
Graylog, New Relic, LightStep

The architecture selected can ensure scalability, reliability, and real-time responsiveness across all system components, from user interfaces to backend processing and IoT device integration.

### Computer System

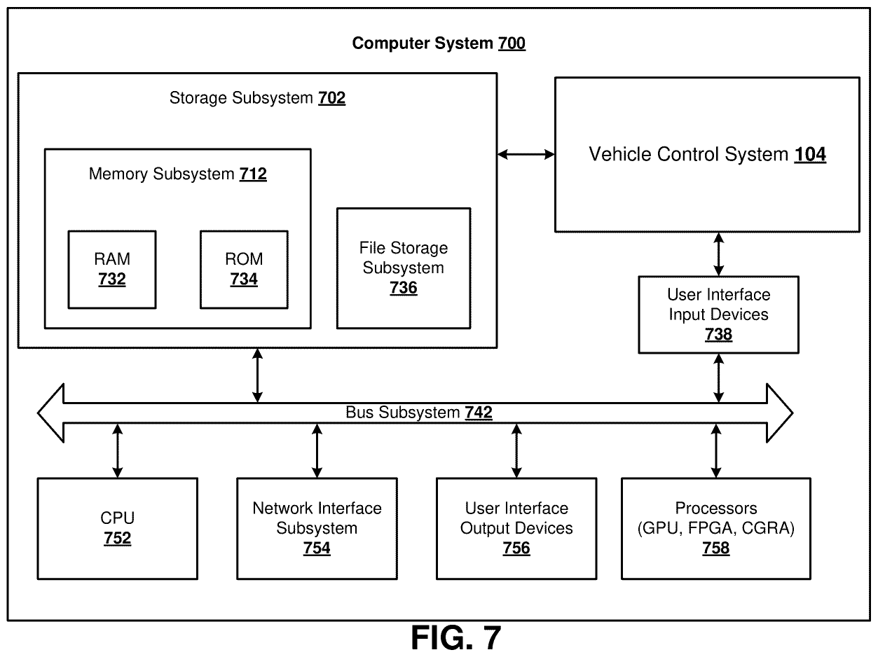

FIG. 7 illustrates a computer system 700 that can be used to implement the technology disclosed, in accordance with certain implementations of the present disclosure. Computer system 700 includes at least one central processing unit (CPU) 752 that communicates with a number of peripheral devices via bus subsystem 742. These peripheral devices can include a storage subsystem 702 including, for example, memory devices and a file storage subsystem 736, user interface input devices 738, user interface output devices 756, and a network interface subsystem 754. The input and output devices allow user interaction with computer system 700. Network interface subsystem 754 provides an interface to outside networks, including an interface to corresponding interface devices in other computer systems.

In one implementation, vehicle control system 104 is communicably linked to the storage subsystem 702 and the user interface input devices 738. In another implementation, the control unit 726 of the depot and the control unit 732 of the transporter are also communicably linked to the storage subsystem 702 and the user interface input devices 738. User interface input devices 738 can include a keyboard; pointing devices such as a mouse, trackball, touchpad, or graphics tablet; a scanner; a touch screen incorporated into the display; and audio input devices such as voice recognition systems and microphones. In general, use of the term “input device” is intended to include all possible types of devices and ways to input information into computer system 700.

User interface output devices 756 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 700 to the user or to another machine or computer system.

Storage subsystem 702 stores programming and data constructs that provide the functionality of some or all of the modules and methods described herein. These software modules are generally executed by processors 758. Processors 758 can be graphics processing units (GPUs), field-programmable gate arrays (FPGAs), application-specific integrated circuits (ASICs), and/or coarse-grained reconfigurable architectures (CGRAs). Processors 758 can be hosted by a deep learning cloud platform such as Google Cloud Platform™, Xilinx™, and Cirrascale™. Examples of processors 778 include Google's Tensor Processing Unit (TPU)™, rackmount solutions like GX4 Rackmount Series™, GX16 Rackmount Series™, NVIDIA DGX-1™, Microsoft' Stratix V FPGA™, Graphcore's Intelligent Processor Unit (IPU)™, Qualcomm's Zeroth Platform™ with Snapdragon processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 712 used in the storage subsystem 702 can include a number of memories including a main random access memory (RAM) 732 for storage of instructions and data during program execution and a read only memory (ROM) 734 in which fixed instructions are stored. A file storage subsystem 736 can provide persistent storage for program and data files, and can include a hard disk drive, a floppy disk drive along with associated removable media, a CD-ROM drive, an optical drive, or removable media cartridges. The modules implementing the functionality of some implementations can be stored by file storage subsystem 736 in the storage subsystem 702, or in other machines accessible by the processor. Bus subsystem 742 provides a mechanism for letting the various components and subsystems of computer system 700 communicate with each other as intended. Although bus subsystem 742 is shown schematically as a single bus, alternative implementations of the bus subsystem can use multiple busses.

Computer system 700 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 700 depicted in FIG. 7 is intended only as a specific example for purposes of illustrating the preferred implementations of the present invention. Many other configurations of computer system 700 are possible having more or less components than the computer system depicted in FIG. 7.

Each of the processors or modules discussed herein may include an algorithm (e.g., instructions stored on a tangible and/or non-transitory computer readable storage medium) or sub-algorithms to perform particular processes. Vehicle control system 104 is illustrated conceptually as a collection of modules, but may be implemented utilizing any combination of dedicated hardware boards, DSPs, processors, etc. Alternatively, system 100 may be implemented utilizing an off-the-shelf PC with a single processor or multiple processors, with the functional operations distributed between the processors. As a further option, the modules described below may be implemented utilizing a hybrid configuration in which some modular functions are performed utilizing dedicated hardware, while the remaining modular functions are performed utilizing an off-the-shelf PC and the like. The modules also may be implemented as software modules within a processing unit.

Various processes and steps of the methods set forth can be carried out using a computer. The computer can include a processor that is part of a detection device, networked with a detection device used to obtain the data that is processed by the computer or separate from the detection device. In some implementations, information (e.g., image data) may be transmitted between components of a system disclosed herein directly or via a computer network. A local area network (LAN) or wide area network (WAN) may be a corporate computing network, including access to the Internet, to which computers and computing devices comprising the system are connected. In one implementation, the LAN conforms to the transmission control protocol/internet protocol (TCP/IP) industry standard. In some instances, the information (e.g., image data) is input to a system disclosed herein via an input device (e.g., disk drive, compact disk player, USB port etc.). In some instances, the information is received by loading the information, e.g., from a storage device such as a disk or flash drive. A processor that is used to run an algorithm or other process set forth herein may comprise a microprocessor. The microprocessor may be any conventional general purpose single-or multi-chip microprocessor such as a Pentium™ processor made by Intel Corporation. A particularly useful computer can utilize an Intel Ivybridge dual-16 core processor, LSI raid controller, having 168 GB of RAM, and 2 TB solid state disk drive. In addition, the processor may comprise any conventional special purpose processor such as a digital signal processor or a graphics processor. The processor typically has conventional address lines, conventional data lines, and one or more conventional control lines.

### Particular Implementations

Many implementations of the technology disclosed relate to methods of configuring tiers of comfort and performance features among vehicles in an autonomous vehicle fleet, including, for a set of vehicles in the autonomous vehicle fleet, a vehicle control system compiling reconfiguration data for each vehicle in the set of vehicles that, when processed by each vehicle, will set a comfort or performance feature to be activated or deactivated, thereby changing user experience of riding in each vehicle. The vehicle control system can establish securely encrypted communication with each vehicle and transmits the reconfiguration data for each vehicle to respective vehicles, and each vehicle can process the reconfiguration data to set the comfort or performance features to an activated state or a deactivated state for at least one ride in the vehicle, thereby changing the user experience for the ride.

In some implementations, the comfort or performance features are controlled by the subsystems in the vehicle, and a premium mode of the comfort or performance features include at least two of a premium mode of reclining seats, an expanded main screen for entertainment and conferencing, a surround sound system with active noise cancellation, enhanced drive performance modes, and/or an expanded luggage capacity. In other implementations, the comfort or performance features are controlled by the subsystems in the vehicle, and a standard mode of the comfort or performance features can include at least one feature that is in the deactivated state. A particular feature in the deactivated state can be a locked out feature, for example, seats that do not recline, a main internal cabin display having a reduced screen size or fewer viewing options, a sound system in a mono or stereo mode, an economy driving mode, and/or a reduced luggage capacity.

One disclosed method includes comfort or premium features in a premium mode, controlled by subsystems in the vehicle, that include at least two of a premium mode of a higher wattage outlet up to 100 watts, a user controllable tint parameter of an electrochromic glass of vehicle windows, and an in seat feature including a lumbar support, a massage mode, a seat cooling parameter, or a seat heating parameter. In another disclosed method, the comfort or performance features in a standard mode, controlled by subsystems in the vehicles, can include at least one feature that is in the deactivated state, and wherein a particular feature in the deactivated state can be a locked out feature such that an outlet is restricted to 20 watts, a tint of a window is invariable, or a seat feature is invariable.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations.

In some implementations of the technology disclosed, the set of vehicles operate in a motorcade mode, the motorcade mode including a set of the comfort or performance features including at least one of a video conferencing feature and a synchronized entertainment feature linked between the vehicles in the set of vehicles. In some disclosed implementations, the synchronized entertainment can include audio media, video media, image media, and/or streaming content presented to a user riding in a vehicle of the set of vehicles via an onboard display or a user device. Audio media could include, as nonlimiting examples, music, a podcast, or an audio call. Video media could include, for example, movies, TV shows, sporting events, live concert footage, and so on.

Other implementations of the technology can involve a motorcade mode that further includes the set of vehicles operating on a convoy configuration. In a convoy, the comfort or performance features can further include configurable exterior lighting coordinated across the vehicles in the convoy. In some implementations, the vehicle control system allocates vehicles in the autonomous vehicle fleet into tiers of services. The allocation can include the vehicle control system responsive to the tracked demand, determining an allocation of the vehicles between the service tiers, wherein the determined allocation is based on proximity of particular vehicles to particular requesting users and corresponding requested tiers of the particular requesting users. The vehicle control system can further determine an allocation of the vehicles between the service tiers, responsive to the tracked demand, wherein the determined allocation is based on proximity of particular vehicles to particular requesting users and corresponding requested tiers of the particular requesting users. The vehicle control system can further initiate the determined allocation of the vehicles.

Other implementations of the technology disclosed relate to any of the aforementioned computer-implemented methods, wherein the vehicle control system receives vehicle ride requests corresponding to particular service tiers and aggregates the received vehicle ride requests as a current market demand across the service tiers, adjusts a count of vehicles in the autonomous vehicle fleet allocated to the particular service tiers, wherein the adjustment is based on a current market demand on a per-hour and per-day basis, and automatically changes the comfort and performance features to activated states and deactivated states to reconfigure the vehicles based on respective assigned tier allocation of the vehicles.

In another implementation, the disclosed methods can further include tracking a demand for vehicles across a region by requested service tiers, and responsive to the tracked demand, determining an allocation of the vehicles between the service tiers, wherein the determined allocation is based on proximity of particular vehicles to particular requesting users and corresponding requested tiers of the particular requesting users. The disclosed methods can also further include initiating the determined allocation of the vehicles.

In certain implementations, the technology disclosed relates to a system for configuring tiers of comfort and performance features among vehicles in an autonomous vehicle fleet. The system can include a set of vehicles in the autonomous vehicle fleet, wherein each vehicle includes subsystems for activating and deactivating comfort and performance features, wherein the subsystems include two or more of a seat subsystem, a screen subsystem, a sound subsystem, a drive mode subsystem and a luggage compartment subsystem, the subsystems controlling activation and deactivation of the features of reclining seats, an expanded main screen for entertainment and conferencing, a surround sound system with active noise cancellation, enhanced drive performance modes and/or expanded luggage capacity. The system can also include a vehicle control system that compiles reconfiguration data for each vehicle in the set of vehicles that, when processed by the subsystems in each vehicle, will set a comfort or performance feature to activated or deactivated, thereby changing user experience of riding in each vehicle. The system can also include a secure establishing securely encrypted communication the vehicle control system that couples the vehicle control system in communication with the subsystems of each vehicle, carrying the reconfiguration data from the vehicle control system to each respective vehicle.

In some disclosed systems, the comfort or performance features, controlled by subsystems in the vehicles, in a premium mode include at least two of: a premium mode of reclining seats, an expanded main screen for entertainment and conferencing, a surround sound system with active noise cancellation, enhanced drive performance modes, and/or an expanded luggage capacity. In other implementations, the comfort or performance features, controlled by subsystems in the vehicles, in a standard mode would include at least one feature that is in a deactivated state, and wherein a particular feature in the deactivated state is a locked out feature such that the seats do not recline, a main internal cabin display having a reduced screen size or fewer viewing options, a sound system in a mono or stereo mode, an economy driving mode, or a reduced luggage capacity. In yet other implementations, the comfort or performance features, controlled by subsystems in the vehicles, in a premium mode include at least two of: a premium mode of a higher wattage outlet up to 100 watts, a user controllable tint parameter of an electrochromic glass of vehicle windows, and an in-seat feature including a lumbar support, a massage mode, a seat cooling parameter, and/or a seat heating parameter. In another implementation, the comfort or performance features, controlled by subsystems in the vehicles, in a standard mode would include at least one feature that is in a deactivated state, and wherein a particular feature in the deactivated state is a locked out feature such that an outlet is restricted to 20 watts, a tint of a window is invariable, and/or a seat feature is invariable. The premium features may include three, four, five, all or any range of feature count being activated or deactivated by the reconfiguration data.

In some disclosed implementations, the set of vehicles operate in a motorcade mode, the motorcade mode including a set of the comfort or performance features including at least one of a video conferencing feature and a synchronized entertainment feature linked between the vehicles in the set of vehicles. In one implementation, the synchronized entertainment can include, for example, at least one of: audio media, video media, image media, or streaming content presented to a user riding in a vehicle of the set of vehicles via an onboard display or a user device.

The technology disclosed can relate to a non-transitory computer readable storage medium impressed with computer program instructions that, upon executed on a processor, implement operations corresponding to any of the disclosed methods herein.

The technology disclosed can be practiced as a system or method for configuring tiers of comfort and performance features among vehicles in an autonomous vehicle fleet. The method is carried by performing the following actions. The system includes hardware and software that implement the following actions. The technology disclosed applies to a set of multiple vehicles in the autonomous vehicle fleet. A vehicle control system compiles reconfiguration data for each vehicle in the set of vehicles that, when processed by each vehicle, will set a comfort or performance feature to activated or deactivated, thereby changing user experience of riding in each vehicle. The vehicle control system establishes securely encrypted communication with each vehicle and transmitting the reconfiguration data for each vehicle to respective vehicles. Each vehicle processes the reconfiguration data to set the comfort or performance features to activated or deactivated for at least one ride in the vehicle, thereby changing the user experience for the ride.

The comfort or performance features, controlled by subsystems in the vehicles, can include in premium mode one, two, three, four or more of: reclining seats, an expanded main screen for entertainment and conferencing, a surround sound system with active noise cancellation, enhanced drive performance modes or expanded luggage capacity. Conversely, in a standard mode, at least some features would be locked out so that seats would not recline, the main screen would offer reduced screen space and fewer viewing options, sound would be mono or stereo instead of surround sound, driving would be limited to economy mode, or luggage capacity would be reduced.

The comfort or performance features, controlled by subsystems in the vehicles, can further include a premium mode one, two, three, four or more of: higher wattage outlets up to 100 watts, user controllable tinting of electrochromic glass of vehicle windows, and in seat features including lumbar, massage, cooling or heating. Conversely, in a standard mode, at least some features would be locked out so that outlets would be restricted to 20 watts, tinting of the glass would not be user controllable, or seat features would not be controllable.

The set of vehicles can operate in a motorcade mode, in which the comfort or performance features include at least one of video conferencing and synchronized entertainment between the vehicles in the set of vehicles. The synchronized entertainment includes music, videos, photos, and streaming content from systems onboard the vehicles or from portable devices carried by users riding in the vehicles.

In a convoy of consecutive vehicles operating in the motorcade mode, the comfort or performance features further include configurable exterior lighting that treats the vehicles in the convoy as a unified palette.

The technology disclosed also can include a system or method for allocating vehicles in the autonomous vehicle fleet to tiers of service. The vehicle control system tracks demand for vehicles across a region by service tier requested. Responsive to the demand, the vehicle control system determines, taking into account proximity of particular vehicles to particular requestors and requested tier, allocation of the vehicles among the tiers. It implements the allocation.

Alternatively stated, the vehicle control system or method can include performing actions of receiving vehicle ride requests across tiers and aggregating the requests as current market demand across the tiers. The technology further includes adjusting and readjusting a count of vehicles in the autonomous ride fleet allocated to the tiers based on current market demand that varies hour-by-hour and day-by-day; and automatically activating and deactivating the comfort and performance features to reconfigure the vehicles based on assigned tier allocation of the vehicles.

Following this alternative, particular vehicles being reconfigured can take into account proximity of the particular vehicles to requestors for particular service tiers.

Any combination of the features described above can be combined with a base system to enhance the system.

Stated in system terminology, the technology disclosed can include a set of vehicles in the autonomous vehicle fleet, wherein each vehicle includes subsystems for activating and deactivating comfort and performance features. The subsystems include two or more of a seat subsystem, a screen subsystem, a sound subsystem, a drive mode subsystem and a luggage compartment subsystem, the subsystems controlling activation and deactivation of the features of reclining seats, an expanded main screen for entertainment and conferencing, a surround sound system with active noise cancellation, enhanced drive performance modes or expanded luggage capacity. The system can further include a vehicle control system that compiles reconfiguration data for each vehicle in the set of vehicles that, when processed by the subsystems in each vehicle, will set a comfort or performance feature to activated or deactivated, thereby changing user experience of riding in each vehicle. The vehicle control system can be coupled by a secure communication with the subsystems of each vehicle, carrying the reconfiguration data from the vehicle control system to each respective vehicle.

The preceding description is presented to enable the making and use of the technology disclosed. Various modifications to the disclosed implementations will be apparent, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein. The scope of the technology disclosed is defined by the appended claims.

The technology disclosed can be implemented as method or as a non-transitory computer readable storage medium storing instructions executable by a processor to perform any of the methods described above. Yet another implementation may include a system including memory and one or more processors operable to execute instructions, stored in the memory, to perform any of the methods described above.

While the present technology is disclosed by reference to the examples detailed above, it is to be understood that these examples are intended in an illustrative rather than in a limiting sense. It is contemplated that modifications and combinations will readily occur to those skilled in the art, which modifications and combinations will be within the spirit of the technology and the scope of the following claims.

What is claimed is:

1. A method for configuring tiers of comfort and performance features among vehicles in an autonomous vehicle fleet, including:
for a set of vehicles in the autonomous vehicle fleet:
a vehicle control system compiling reconfiguration data for each vehicle in the set of vehicles that, when processed by each vehicle, will set a comfort or performance feature to be activated or deactivated, thereby changing user experience of riding in each vehicle,
the vehicle control system establishing securely encrypted communication with each vehicle and transmitting the reconfiguration data for each vehicle to respective vehicles, and
each vehicle processing the reconfiguration data and setting the comfort or performance features to an activated state or a deactivated state for at least one ride in the vehicle, thereby changing the user experience for the ride.

2. The method of claim 1, wherein the comfort or performance features, controlled by subsystems in the vehicles, in a premium mode include at least two of: reclining seats, an expanded main screen for entertainment and conferencing, a surround sound system with active noise cancellation, enhanced drive performance modes, or an expanded luggage capacity.

3. The method of claim 1, wherein the comfort or performance features, controlled by subsystems in the vehicles, in a standard mode would include at least one feature that is in the deactivated state, and wherein a particular feature in the deactivated state is a locked out feature such that seats do not recline, a main internal cabin display having a reduced screen size or fewer viewing options, a sound system in a mono or stereo mode, an economy driving mode, or a reduced luggage capacity.

4. The method of claim 1, wherein the comfort or performance features, controlled by subsystems in the vehicles, in a premium mode include at least two of a higher wattage outlet up to 100 watts, a user controllable tint parameter of an electrochromic glass of vehicle windows, and an in seat feature including a lumbar support, a massage mode, a seat cooling parameter, or a seat heating parameter.

5. The method of claim 1, wherein the comfort or performance features, controlled by subsystems in the vehicles, in a standard mode would include at least one feature that is in the deactivated state, and wherein a particular feature in the deactivated state is a locked out feature such that an outlet is restricted to 20 watts, a tint of a window is invariable, or a seat feature is invariable.

6. The method of claim 1, further including the set of vehicles operating in a motorcade mode, the motorcade mode including a set of the comfort or performance features including at least one of a video conferencing feature and a synchronized entertainment feature linked between the vehicles in the set of vehicles.

7. The method of claim 6, wherein the synchronized entertainment feature further includes audio media, video media, image media, or streaming content presented to a user riding in a vehicle of the set of vehicles via an onboard display or a user device.

8. The method of claim 6, wherein the motorcade mode further includes the set of vehicles operating in a convoy of consecutive vehicles.

9. The method of claim 8, wherein the comfort or performance features further include configurable exterior lighting coordinated across the consecutive vehicles in the convoy.

10. The method of claim 1, wherein the vehicle control system allocates vehicles in the autonomous vehicle fleet into tiers of service, the allocation including the vehicle control system:
tracking a demand for vehicles across a region by requested service tiers;
responsive to the tracked demand, determining an allocation of the vehicles between the service tiers, wherein the determined allocation is based at least in part on proximity of particular vehicles to particular requesting users and corresponding requested tiers of the particular requesting users; and
initiating the determined allocation of the vehicles.

11. The method of claim 1, further including the vehicle control system:
receiving vehicle ride requests corresponding to particular service tiers and aggregates the received vehicle ride requests as a current market demand across the service tiers;
adjusting a count of vehicles in the autonomous vehicle fleet allocated to the particular service tiers, wherein the adjustment is based at least in part on a current market demand on a per-hour and per-day basis; and
automatically changing the comfort and performance features to activated states and deactivated states to reconfigure the vehicles based on respective assigned tier allocation of the vehicles.

12. A system for configuring tiers of comfort and performance features among vehicles in an autonomous vehicle fleet, including:
a set of vehicles in the autonomous vehicle fleet, wherein each vehicle includes subsystems for activating and deactivating comfort and performance features, wherein the subsystems include two or more of a seat subsystem, a screen subsystem, a sound subsystem, a drive mode subsystem and a luggage compartment subsystem, the subsystems controlling activation and deactivation of the features of reclining seats, an expanded main screen for entertainment and conferencing, a surround sound system with active noise cancellation, enhanced drive performance modes or expanded luggage capacity;
a vehicle control system that compiles reconfiguration data for each vehicle in the set of vehicles that, when processed by the subsystems in each vehicle, will set a comfort or performance feature to activated or deactivated, thereby changing user experience of riding in each vehicle; and
a secure encrypted communication channel that couples the vehicle control system in communication with the subsystems of each vehicle, carrying the reconfiguration data from the vehicle control system to each respective vehicle.

13. The system of claim 12, wherein the comfort or performance features, controlled by subsystems in the vehicles, in a premium mode include at least two of reclining seats, an expanded main screen for entertainment and conferencing, a surround sound system with active noise cancellation, enhanced drive performance modes, or an expanded luggage capacity.

14. The system of claim 12, wherein the comfort or performance features, controlled by subsystems in the vehicles, in a standard mode would include at least one feature that is in a deactivated state, and wherein a particular feature in the deactivated state is a locked out feature such that the seats do not recline, a main internal cabin display having a reduced screen size or fewer viewing options, a sound system in a mono or stereo mode, an economy driving mode, or a reduced luggage capacity.

15. The system of claim 12, wherein the comfort or performance features, controlled by subsystems in the vehicles, in a premium mode include at least two of a higher wattage outlet up to 100 watts, a user controllable tint parameter of an electrochromic glass of vehicle windows, and an in seat feature including a lumbar support, a massage mode, a seat cooling parameter, or a seat heating parameter.

16. The system of claim 12, wherein the comfort or performance features, controlled by subsystems in the vehicles, in a standard mode would include at least one feature that is in a deactivated state, and wherein a particular feature in the deactivated state is a locked out feature such that an outlet is restricted to 20 watts, a tint of a window is invariable, or a seat feature is invariable.

17. The system of claim 12, wherein the set of vehicles operate in a motorcade mode, the motorcade mode including a set of the comfort or performance features including at least one of a video conferencing feature and a synchronized entertainment feature linked between the vehicles in the set of vehicles.

18. The system of claim 17, wherein the synchronized entertainment includes audio media, video media, image media, or streaming content presented to a user riding in a vehicle of the set of vehicles via an onboard display or a user device.

19. A non-transitory computer readable storage medium impressed with computer program instructions that, upon executed on processors of vehicles and a control system, implement a method comprising:
for a set of vehicles in an autonomous vehicle fleet:
a vehicle control system compiling reconfiguration data for each vehicle in the set of vehicles that, when processed by each vehicle, will set a comfort or performance feature to be activated or deactivated, thereby changing user experience of riding in each vehicle,
the vehicle control system establishing securely encrypted communication with each vehicle and transmitting the reconfiguration data for each vehicle to respective vehicles, and
each vehicle processing the reconfiguration data and setting the comfort or performance features to an activated state or a deactivated state for at least one ride in the vehicle, thereby changing the user experience for the ride.
